(19) United States
(12) Patent Application Publication
(10) Pub. No.: US 2018/0048554 A1
(43) Pub. Date: Feb. 15, 2018

(54) MONITORING APPARATUS AND RELATED METHOD

(71) Applicant: GOOEE LIMITED, Sheung Wan (HK)

(72) Inventors: JI-DE HUANG, HSINCHU CITY (TW); CHUN-KUANG CHEN, TAOYUAN CITY (TW); TUNG-YU CHEN, HSINCHU COUNTY (TW)

(21) Appl. No.: 15/672,704

(22) Filed: Aug. 9, 2017

Related U.S. Application Data
(60) Provisional application No. 62/512,834, filed on May 31, 2017.

(30) Foreign Application Priority Data
Aug. 12, 2016 (TW) 105125695
Aug. 12, 2016 (TW) 105125696
Jan. 20, 2017 (TW) 106102010
Apr. 28, 2017 (TW) 106114265

(51) Int. Cl. H04L 12/26; H04W 56/00; H04L 7/00; H04L 12/24

(52) U.S. Cl. CPC H04L 43/106; H04L 41/0681; H04W 56/0015; H04L 7/0075; H04L 67/12

(57) ABSTRACT

A monitoring apparatus includes: a first operational device arranged to perform a first predetermined function and accordingly transmit a first instruction signal; a second operational device arranged to receive a second instruction signal and accordingly perform a second predetermined function; a first monitoring device coupled to the first operational device for generating a first detecting event according to an operation of the first operational device; and a second monitoring device coupled to the second operational device for generating a second detecting event according to the operation of the second operational device. The first monitoring device is wirelessly coupled to the second monitoring device, and the first detecting event and the second detecting event are used to determine if the first operational device and the second operational device perform the first predetermined function and the second predetermined function respectively.

### BACKGROUND

The Internet of things (IoT) is a concept of interconnection among physical devices, vehicles, buildings, and other items. IoT is expected to offer advanced connectivity of devices, systems, and services that goes beyond machine-to-machine (M2M) communications and covers a variety of protocols, domains, and applications. The interconnection of these devices is expected to in nearly all fields, while also enabling advanced applications like a smart grid, and expanding to areas such as smart cities. The technology of Mesh Network is wildly used in IOT application. However, this technology has drawbacks of limited node number, communication range, and data rate.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating a mesh network system in accordance with some embodiments.

FIG. 2 is a diagram illustrating a time synchronization between two monitoring devices in accordance with some embodiments.

FIG. 3 is a diagram illustrating an example of transmitting an instruction signal in the mesh network system in accordance with some embodiments.

FIG. 4 is a diagram illustrating an example of transmitting an instruction signal in the mesh network system in accordance with some embodiments.

FIG. 5 is a diagram illustrating a monitoring device in accordance with some embodiments.

FIG. 6 is a diagram illustrating two monitoring devices in accordance with some embodiments.

FIG. 7 is a flowchart illustrating a monitoring method in accordance with some embodiment.

FIG. 8A is a schematic view illustrating a coordinate sensing device according to one embodiment of the present invention.

FIG. 8B is a schematic view illustrating the use of a coordinate sensing device of the present invention to output a coordinate of an object according to one embodiment.

FIG. 8C is a schematic view illustrating the use of a coordinate sensing device of the present invention to output a coordinate of an object according to another embodiment.

FIG. 8D is a schematic view illustrating the use of a coordinate sensing device of the present invention to output a coordinate of an object according to another embodiment.

FIG. 8E is a schematic view illustrating the use of a coordinate sensing device of the present invention to output a coordinate of an object according to another embodiment.

FIG. 8F is a top view illustrating the use of a coordinate sensing device of the present invention to scan an object according to another embodiment.

FIG. 8G is an oscillogram of a receiving signal generated by a present receiver according to one embodiment.

FIG. 8H is a top view illustrating the use of a coordinate sensing device of the present invention to scan an object according to another embodiment.

FIG. 8I is an oscillogram of a receiving signal generated by a present receiver according to another embodiment.

FIG. 8J is a top view illustrating the use of a coordinate sensing device of the present invention to output a three-dimensional coordinate of an object according to one embodiment.

FIG. 8K is a top view illustrating the use of a coordinate sensing device of the present invention to scan an object according to another embodiment.

FIG. 9A is a schematic view illustrating a coordinate sensing device according to one embodiment of the present invention.

FIG. 9B is a schematic view illustrating the use of a coordinate sensing device of the present invention to output a coordinate of an object according to one embodiment.

FIG. 9C is a schematic view illustrating the use of a coordinate sensing device of the present invention to output a coordinate of an object according to another embodiment.

FIG. 9D is a schematic view illustrating the use of a coordinate sensing device of the present invention to output a coordinate of an object according to another embodiment.

FIG. 9E is schematic view illustrating the use of a coordinate sensing device of the present invention to output a coordinate of an object according to another embodiment.

FIG. 9F is a top view illustrating the use of a coordinate sensing device of the present invention to scan an object according to another embodiment.

FIG. 9G is an oscillogram of a receiving signal generated by a present receiver according to one embodiment.

FIG. 9H is a top view illustrating the use of a coordinate sensing device of the present invention to scan an object according to another embodiment.

FIG. 9I is an oscillogram of a receiving signal generated by a present receiver according to another embodiment.

FIG. 9J is a top view illustrating the use of a coordinate sensing device of the present invention to scan two objects according to one embodiment.

FIG. 9K is a top view illustrating the use of a coordinate sensing device of the present invention to scan an object according to another embodiment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Embodiments of the present disclosure are discussed in detail below. It should be appreciated, however, that the present disclosure provides many applicable inventive concepts that can be embodied in a wide variety of specific contexts. The specific embodiments discussed are merely illustrative and do not limit the scope of the disclosure.

Further, spatially relative terms, such as “beneath,” “below.” “lower,” “above,” “upper”, “lower”, “left”, “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. It will be understood that when an element is referred to as being “connected to” or “coupled to” another element, it may be directly connected to or coupled to the other element, or intervening elements may be present.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

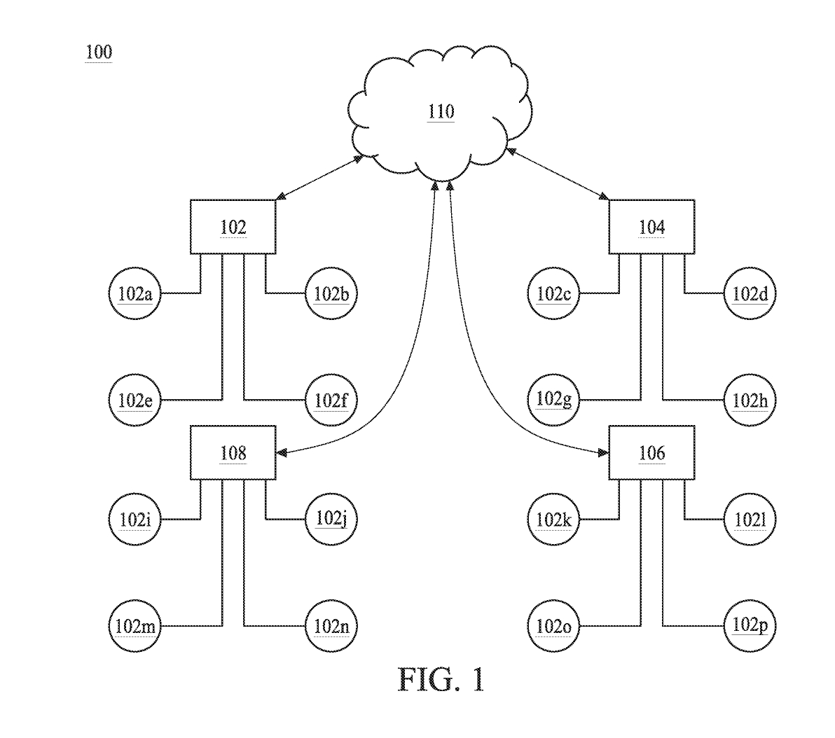

FIG. 1 is a diagram illustrating a mesh network system 100 in accordance with some embodiments. The mesh network system 100 comprises a plurality of operational devices 102a˜102p and a plurality of monitoring devices 102, 104, 106, and 108. The operational devices 102a˜102p are distributed on a large-scale field. Each of the operational devices 102a˜102p is configured to perform a predetermined function. For example, the predetermined function may be an illumination control of a lighting device. For brevity, the operational devices 102a˜102p are illustrated as a plurality of nodes respectively as shown in FIG. 1. The operations of the operational devices 102a˜102p are controlled by a controller (not shown). The controller may be wirelessly connected or wire-coupled to the operational devices 102a˜102p. The controller may transmit instruction(s) to one or more of the operational devices 102a˜102p for controlling their predetermined functions via a Gateway (not shown). The Gateway may be wirelessly connected or wire-coupled to the operational devices 102a˜102p.

Furthermore, each of the operational devices 102a˜102p is further arranged to relay data or instruction for the network. Therefore, all the operational devices 102a˜102p are arranged to corporately distribute data in the network. Ideally, the operational devices 102p are all directly or indirectly connected with each other. For example, when one of the operation devices 102a˜102p receives an instruction from the Gateway, and when the operation device is functional work, the operation device may pass the instruction to the next operation device(s). The next operation device may pass the instruction to the another operation device(s) when the next operation device is functional work. Accordingly, the instruction may be distributed to all of the operational devices 102a˜102p. According to some embodiments, the connection between two operational devices may be established by using any existing wireless communication technique, e.g. Zigbee.

However, in practice, some of the operational devices 102a˜102p may fail to perform their predetermined functions due to, for example, their limited lifetime. In the large-scale field, the failed operational devices may not easily be founded manually among the huge number of operational devices. Accordingly, in the present embodiment, a plurality of monitoring devices, e.g. the monitoring devices 102, 104, 106, and 108, are developed to automatically monitor the operational devices 102a˜102p respectively. According to the present embodiment, the mesh network system 100 may be applied to monitor a lighting system of a large-scale field, such as a lighting system in a shopping mall or a multi-story building.

According to some embodiments, the monitoring device 102 is arranged to monitor the operation of the operational devices 102a˜102d. The monitoring device 104 is arranged to monitor the operation of the operational devices 102e˜102h. The monitoring device 106 is arranged to monitor the operation of the operational devices 102i˜102l. The monitoring device 108 is arranged to monitor the operation of the operational devices 102m˜102p. It is noted that the number of monitoring devices and the number of operational devices monitored by each monitoring device are just examples, which are not the limitation of the present invention. According to the present embodiments, at least two monitoring devices are used to monitor a plurality monitoring devices in a field. A monitoring device may be capable of monitoring a predetermined or limited number of operational devices. The number of the monitoring devices may be adjusted depending on the number of the operational devices.

The monitoring devices 102, 104, 106, and 108 are further arranged to wirelessly transmit the monitored results corresponding to the operational devices 102a˜102p to an external or remote processing system 110. The remote processing system 110 may be a cloud computing system or a cloud server. The remote processing system 110 at least comprises a processing device for analyzing or processing the monitored results received from the monitoring devices 102, 104, 106, and 108. It is noted that cloud computing is a type of Internet-based computing that provides shared computer processing resources and data to computers and other devices on demand. It is a model for enabling ubiquitous, on-demand access to a shared pool of configurable computing resources (e.g., computer networks, servers, storage, applications and services), which can be rapidly provisioned and released with minimal management effort.

According to some embodiments, the connection between a monitoring device (e.g. the monitoring device 102) and the corresponding operational devices (e.g. the operational devices 102a˜102d) is implemented by a connecting device for conveying the corresponding acknowledgement signals respectively. The connecting device may comprise a plurality of connecting wires or lines connected between the monitoring device and the corresponding operational devices respectively. For example, in FIG. 1, the connecting wires between the monitoring device 102 and the operational devices 102a˜102d are illustrated as 112a˜112d respectively.

According to some embodiments, the connecting device may be implemented by an Universal Asynchronous Receiver/Transmitter (UART). The UART may be a microchip with programming that controls the interface of a monitoring device (e.g. the monitoring device 102) to its attached operational devices (e.g. the operational devices 102a˜102d).

According to some embodiments, the connecting device may be implemented by an Inter-Integrated Circuit (I2C). The I2C is used for attaching the operational devices (e.g. the operational devices 102a˜102d) to the corresponding monitoring device (e.g. the monitoring device 102) in short-distance, intra-board communication. The I2C may be a multi-master, multi-slave, packet switched, single-ended, serial computer bus.

According to some embodiments, the connecting device may be implemented by a Serial Peripheral Interface bus (SPI). The SPI is a synchronous serial communication interface specification used for short distance communication, primarily in embedded systems. An SPI device communicate in full duplex mode using a master-slave architecture with a single master (e.g. the monitoring device 102) and multiple slave devices (e.g. the operational devices 102a˜102d). Multiple slave devices are supported through selection with individual slave select (SS) lines.

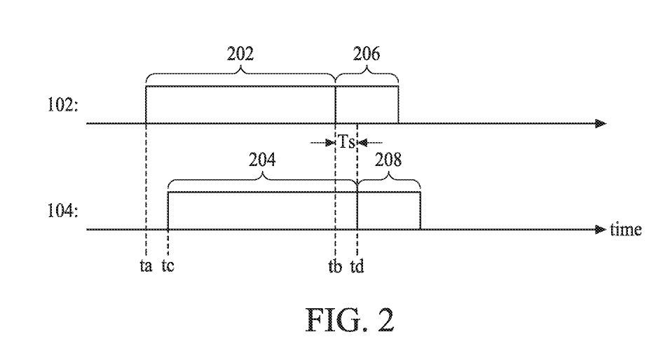

In addition, the monitoring devices 102, 104, 106, and 108 are capable of communicating with each other by using any existing wireless communication technique. Specifically, the operating clock signals of the monitoring devices 102, 104, 106, and 108 are time synchronized with each other by using the technique of Reference Broadcast Synchronization (RBS). FIG. 2 is a diagram illustrating the time synchronization between two monitoring devices in the field of the mesh network system 100 in accordance with some embodiments. For brevity, the monitoring device 102 and the monitoring device 104 are used to illustrate the operation of time synchronization of the present embodiment. It is noted that the time synchronization can be expanded to the synchronization among the monitoring devices 102, 104, 106, and 108. Specifically, during the synchronization, a beacon is wirelessly transmitted to the monitoring devices 102 and 104. The beacon may be sent from a cloud computing system or a cloud server. For example, the cloud computing system may be the remote processing system 110. The monitoring device 102 and the monitoring device 104 may exchange the timing information of the received beacons to perform the time synchronization between their operating clock signals respectively. For example, in FIG. 2, a packet is wirelessly transmitted to the monitoring device 104 from the monitoring device 102. According to some embodiments, a timestamp may be attached to an end of the packet. The timestamp indicates or includes the receiving time of the beacon received by the monitoring device 102. In FIG. 2, the curve 202 indicates the time domain of transmitting the packet by the monitoring device 102. The curve 204 indicates the time domain of receiving the packet by the monitoring device 104. The monitoring device 102 transmits the packet 202 at time ta, and transmits the corresponding timestamp 206 at time tb. The monitoring device 104 receives the packet 204 at time tc, and receives the corresponding timestamp 208 at time td. The monitoring device 104 is arranged to read or decipher the timestamp 206 to obtain the receiving time of the beacon received by the monitoring device 102. When the beacon receiving time of the monitoring device 102 is obtained by the monitoring device 104, the monitoring device 104 may calculate the offset between the beacon receiving time of the monitoring device 102 and the beacon receiving time of the monitoring device 104. According to some embodiments, the offset corresponds to the phase shift between the operating clock signal of the monitoring device 102 and the operating clock signal of the monitoring device 104. Accordingly, the monitoring device 102 and the monitoring device 104 may synchronize their operating clock signals respectively based on the offset or the phase shift. Although a propagation time Ts, e.g. the time difference between tb and td, exists between the packet 202 and the packet 204, the propagation time Ts may be ignored if the transmission range is relatively small.

It is noted that, by using the technique of RBS, the time synchronization between the monitoring devices 102 and 104 is based on the offset between the beacon receiving time, and the time synchronization between the monitoring devices 102 and 104 is not based on the sending time of the beacon sent from the remote processing system 110. Therefore, the technique of RBS removes the uncertainty of the sender by removing the sender, i.e. the remote processing system 110, from the critical path. By removing the sender, the only uncertainty is the propagation and receiving times of the monitoring devices 102 and 104. Therefore, the monitoring devices 102 and 104 may obtain relatively precise clock synchronization.

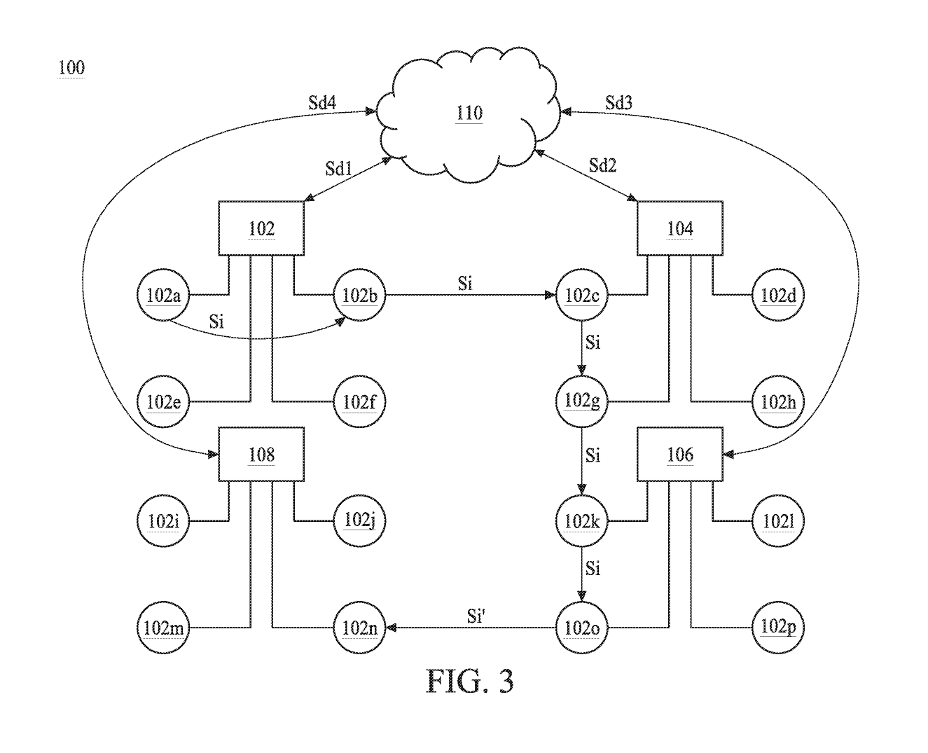

FIG. 3 is a diagram illustrating an example of transmitting an instruction signal Si in the mesh network system 100 in accordance with some embodiments. The instruction signal Si is arranged to control an operational device to perform its predetermined function. For example, if the operational device is a lighting device, the instruction signal Si is used to turn-on, turn-off, or adjusting illumination of the lighting device. For brevity, the operation of the monitoring devices 102, 104, 106, and 108 is described by transmitting the instruction signal Si from the operational device 102a to the operational device 102n by an order of the operational device 102a, the operational device 102b, the operational device 102c, the operational device 102g, the operational device 102k, the operational device 102o, and the operational device 102n. However, this is not a limitation of the present embodiment.

At time t1, when the predetermined function of the operational device 102a works, the instruction signal Si is transmitted by the operational device 102a to the operational device 102b, and the monitoring device 102 records the transmitting time t1. At time t2, the instruction signal Si is received by the operational device 102b, and the monitoring device 102 records the receiving time t2. At time t3, when the predetermined function of the operational device 102b works, the instruction signal Si is transmitted by the operational device 102b to the operational device 102c, and the monitoring device 102 records the transmitting time t3. When the instruction signal Si is transmitted to the operational device 102c from the operational device 102b, the monitoring device 102 transmits a first detecting event or packet Sd1 including the information of times t1, t2, and t3 to the remote processing system 110.

At time t4, the instruction signal Si is received by the operational device 102c, and the monitoring device 104 records the receiving time t4. At time t5, when the predetermined function of the operational device 102c works, the instruction signal Si is transmitted by the operational device 102c to the operational device 102g, and the monitoring device 104 records the transmitting time t5. At time t6, the instruction signal Si is received by the operational device 102g, and the monitoring device 104 records the receiving time t6. At time t7, when the predetermined function of the operational device 102g works, the instruction signal Si is transmitted by the operational device 102g to the operational device 102k, and the monitoring device 104 records the transmitting time t7. When the instruction signal Si is transmitted to the operational device 102k from the operational device 102g, the monitoring device 104 transmits a second detecting event Sd2 including the information of times t4, t5, t6, and t7 to the remote processing system 110.

At time t8, the instruction signal Si is received by the operational device 102k, and the monitoring device 106 records the receiving time t8. At time t9, when the predetermined function of the operational device 102k works, the instruction signal Si is transmitted by the operational device 102k to the operational device 102o, and the monitoring device 106 records the transmitting time t9. At time t10, the instruction signal Si is received by the operational device 102o, and the monitoring device 106 records the receiving time t10. At time t11, when the predetermined function of the operational device 102o works, the instruction signal Si is transmitted by the operational device 102o to the operational device 102n, and the monitoring device 106 records the transmitting time t11. When the instruction signal Si is transmitted to the operational device 102n from the operational device 102o, the monitoring device 106 transmits a third detecting event Sd3 including the information of times t8, t9, t10, and t11 to the remote processing system 110.

At time t12, the instruction signal Si is received by the operational device 102n, and the monitoring device 108 records the receiving time t12. When the instruction signal Si is received by the operational device 102n and the predetermined function of the operational device 108a works, the monitoring device 108 transmits a fourth detecting event Sd4 including the information of time t12 to the remote processing system 110.

According to some embodiment, when the remote processing system 110 receives the first detecting event Sd1, the remote processing system 110 is arranged to process or analyze the first detecting event Sd1 in order to determine if the predetermined functions of the operational device 102a and the operational device 102b work. When the remote processing system 110 founds that the first detecting event Sd1 includes the information of times t1, t2, and t3, it means that the instruction signal Si is successfully transmitted to the operational device 102c by an order of the operational device 102a, the operational device 102b, and the operational device 102c. Then, the remote processing system 110 determines that the operational device 102a and the operational device 102b are functional-work. However, when the remote processing system 110 founds that the detecting event merely includes the information of times t1 and t2, it means that the instruction signal Si is just transmitted to the operational device 102b from the operational device 102a, and the instruction signal Si is not transmitted to the operational device 102c from the operational device 102b. Then, the remote processing system 110 determines that the operational device 102a is functional-work and the operational device 102b is functional-fail. In other words, when the operational device 102b is functional-fail, the operational device 102b merely receives the instruction signal Si at time t2, and the operational device 102b does not transmit the instruction signal Si to the operational device 102c at time t3. When operational device 102b does not transmit the instruction signal Si to the operational device 102c at time t3, the first detecting event Sd1 may not has the information of time t3. It is noted that the remote processing system 110 uses the similar method to determine the functional of the following operational devices 102c, 102g, 102k, 102o, and 102n based on the received detecting events Sd2, Sd3, and Sd4. Thus, the detailed description is omitted for brevity.

Accordingly, the operation of the operational devices 102a˜102p in the large-scale field may be effectively monitored by the monitoring devices 102, 104, 106, and 108 respectively.

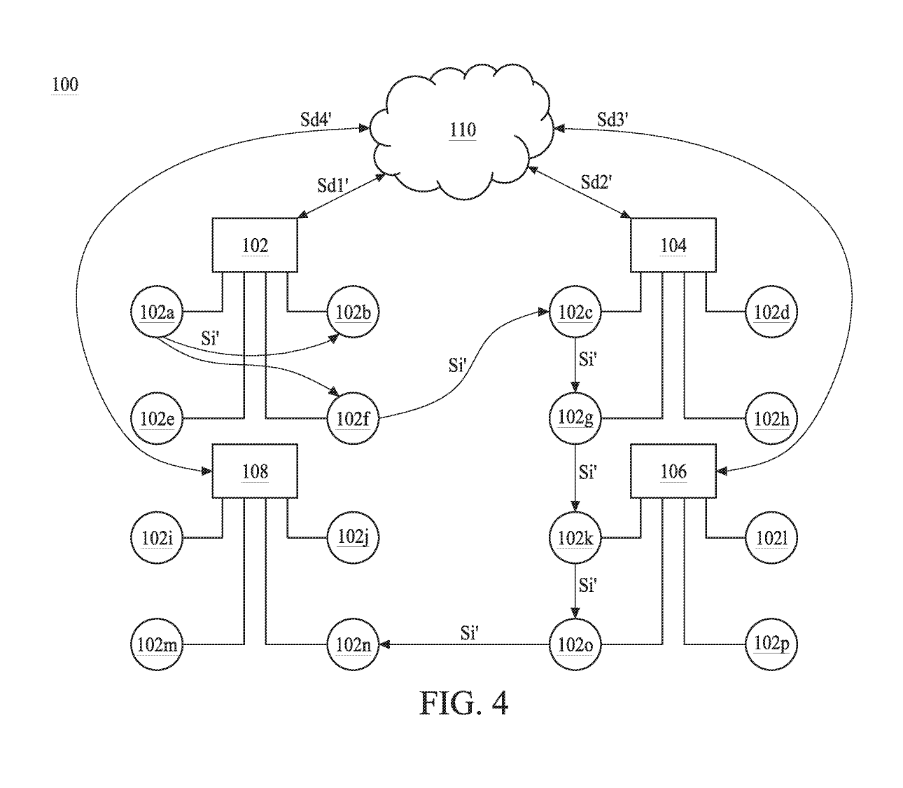

According to some embodiments, if the operational device 102b is functional-fail, the instruction signal Si may re-transmit to the operational device 102f from the operational device 102a as shown in FIG. 4. FIG. 4 is a diagram illustrating an example of transmitting an instruction signal Si′ in the mesh network system 100 in accordance with some embodiments. For brevity, the operation of the monitoring devices 102, 104, 106, and 108 is described by transmitting the instruction signal Si′ from the operational device 102a to the operational device 102n by an order of the operational device 102a, the operational device 102b, the operational device 102f, the operational device 102c, the operational device 102g, the operational device 102k, the operational device 102o, and the operational device 102n. However, this is not a limitation of the present embodiment.

At time t1′, when the predetermined function of the operational device 102a works, the instruction signal Si′ is transmitted by the operational device 102a to the operational device 102b, and the monitoring device 102 records the transmitting time t1′. However, the operational device 102b does not receive the instruction signal Si′ because the operational device 102b is functional-fail. Then, at time t2′, the operational device 102a re-transmits the instruction signal Si′ to another operational device (i.e. 102f), which is also monitored by the monitoring device 102, and the monitoring device 102 records the transmitting time t2′. At time t3′, the instruction signal Si′ is received by the operational device 102f, and the monitoring device 102 records the receiving time t3′. At time t4′, when the predetermined function of the operational device 102f works, the instruction signal Si′ is transmitted by the operational device 102f to the operational device 102c, and the monitoring device 102 records the transmitting time t4′. When the instruction signal Si′ is transmitted to the operational device 102c from the operational device 102f, the monitoring device 102 transmits a first detecting event or packet Sd1′ including the information of times t1′, t2′, t3′, t4′ to the remote processing system 110.

When the remote processing system 110 receives the first detecting event Sd1′, the remote processing system 110 is arranged to process or analyze the first detecting event Sd1′ in order to determine the operation of the operational device 102a, the operational device 102b, and the operational device 102f. When the remote processing system 110 founds that the first detecting event Sd1′ includes the information of times t1′, t2′, t3′, and t4′, it means that the instruction signal Si′ is successfully transmitted to the operational device 102c by an order of the operational device 102a, the operational device 102b, the operational device 102a, the operational device 102f, and the operational device 102c. Accordingly, the remote processing system 110 determines that the operational device 102a and the operational device 102f are functional-work, and the operational device 102b is functional-fail.

The instruction signal Si is then transmitted to the operational device 102n from the operational device 102c by an order of the operational device 102c, the operational device 102g, the operational device 102k, the operational device 102o, and the operational device 102n. The monitoring devices 104, 106, and 108 transmit the corresponding second detecting event Sd2′, third detecting event Sd3′, and fourth detecting event Sd4′ to the remote processing system 110. The remote processing system 110 is arranged to determine the operation of the operational devices 102c, 102g, 102k, 102o, and 102n based on the second detecting event Sd2′, third detecting event Sd3′, and fourth detecting event Sd4′ respectively. As the operation is similar to the operation of FIG. 3, the detailed description is omitted for brevity.

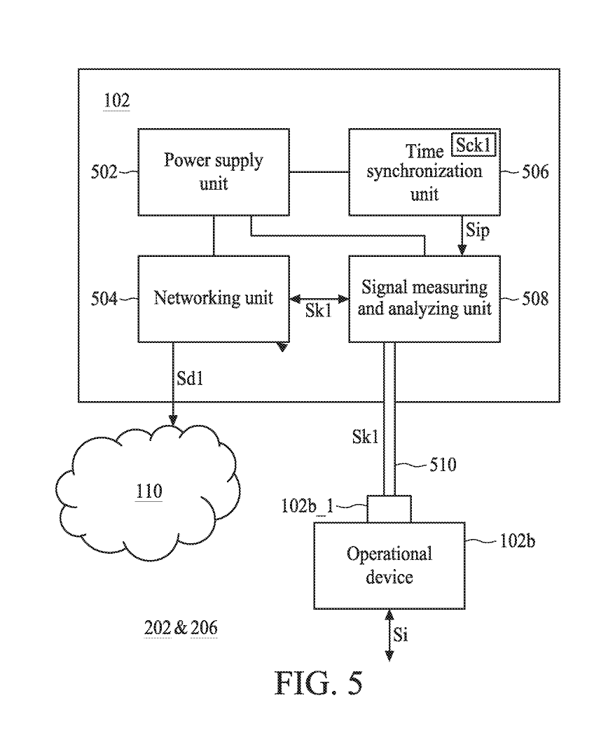

According to some embodiments, the monitoring devices 102, 104, 106, and 108 are configured to have a similar configuration. FIG. 5 is a diagram illustrating the operation of one monitoring device (e.g. the monitoring device 102) in accordance with some embodiments.

For the purpose of description, the operational device 102b is also shown in FIG. 5. The monitoring device 102 is arranged to monitor the operation of the operational device 102b. According to some embodiments, the monitoring device 102 comprises a power supply unit 502, a networking unit 504, a time synchronization unit 506, a signal measuring and analyzing unit 508, and a connecting device 510. In addition, the operational device 102b comprises a General Purpose Input/Output (GPIO) pin 102b_1.

For the monitoring device 102, the power supply unit 502 is arranged to supply power to the operational device 102b, the networking unit 504, the time synchronization unit 506, and the signal measuring and analyzing unit 508. According to some embodiments, the power supply unit 502 may comprises a converter for converting AC (Alternative Current) or DC (Direct Current) signal into the voltage levels required by the operational device 102b, the networking unit 504, the time synchronization unit 506, and the signal measuring and analyzing unit 508 respectively. For example, the voltage level may be 5V or 3.3V.

The time synchronization unit 506 is arranged to generate a clock signal Sck1. The clock signal Sck1 is synchronized with the clock signals of other monitoring devices (not shown in FIG. 5) via the technique of RBS. By using the technique of RBS, the time error between the clock signal Sck1 and the other clock signals can be reduced to a relatively small range. When the time error between the clock signal Sck1 and the other clock signals is small, the information in the timestamp of the packet generated or received by the monitoring device 102 is relatively accurate. For example, the time error may be smaller than 1 us, e.g. 50 ns.

For example, the clock signal Sck1 of the time synchronization unit 506 is set to be the reference clock or reference time. Then, the other clock signals of the other monitoring devices synchronize with the clock signal Sck1 by using the technique of RBS.

According to some embodiments, the time synchronization unit 506 may synchronize with the time synchronization units of other monitoring devices via the technique of GPS. For example, when the mesh network system 100 is applied in a wide environment, the time synchronization unit 506 performs synchronization with the other time synchronization units through GPS.

Furthermore, the time synchronization unit 506 may transmit an impulse signal Sip to the signal measuring and analyzing unit 508. For example, the time synchronization unit 506 may transmit the impulse signal Sip to the signal measuring and analyzing unit 508 in every 10 ms. The signal measuring and analyzing unit 508 is arranged to reset or start a counting time upon the receiving of the impulse signal Sip. According to some embodiments, the time synchronization unit 506 and the signal measuring and analyzing unit 508 are arranged to have a crystal oscillator (or a counter) respectively. The signal measuring and analyzing unit 508 is arranged to use its crystal oscillator or the counter to count the time difference between two contiguous impulse signals Sip received from the time synchronization unit 506. As mentioned above, the time difference between two contiguous impulse signals Sip received from the time synchronization unit 506 is 10 ms, thus the signal measuring and analyzing unit 508 can use the time space of 10 ms to modify or correct the counting time. By using the time difference of two impulse signals Sip to be the reference time, the error of the counting time of the signal measuring and analyzing unit 508 can be less than 1 us.

The connecting device 510 is coupled between the signal measuring and analyzing unit 508 and the operational device 102b. The connecting device 510 may be a Serial Peripheral Interface (SPI) bus, an Universal Asynchronous Receiver/Transmitter (UART), or an Inter-Integrated Circuit (I2C) coupled to the GPIO pin 102b_1 of the operational device 102b. The signal measuring and analyzing unit 508 is arranged for analyzing an acknowledgement signal Sk1 on the connecting device 510 received from the operational device 102b to obtain the time at which the operational device 102b transmitting the instruction signal Si. Every time the operational device 102b performs an operation of wireless communicating, the operational device 102b transmits a copy (i.e. the acknowledgement signal Sk1) of received packet or transmitted packet to the signal measuring and analyzing unit 508 via the connecting device 510. When the state of the operational device 102b is changed, e.g., from the normal operation mode to the sleep mode, the operational device 102b also transmits the state (i.e. the acknowledgement signal Sk1) to the signal measuring and analyzing unit 508 via the connecting device 510.

Every time the operational device 102b receives packet and the state of GPIO pin 102b_1 is changed, the signal measuring and analyzing unit 508 records the packet and the state. The signal measuring and analyzing unit 508 also records the corresponding occur time of the packet and the state. According to some embodiments, when the state of the GPIO pin 102b_1 is changed from a first level to a second level different from the first level, the operational device 102b may record the instant timestamp and the instant level for generating an event, i.e. the acknowledgement signal Sk1. The acknowledgement signal Sk1 is transmitted to the networking unit 504 via the connecting device 510. The networking unit 504 buffers the acknowledgement signal Sk1 and transmits the acknowledgement signal Sk1 to the signal measuring and analyzing unit 518.

For example, when the operational device 102b receives a packet, the operational device 102b changes the state of the GPIO pin 102b_11 to a high voltage level from a low voltage level, and records the instant timestamp of receiving the packet. Then, the operational device 102b generates an event packet including the information of the instant timestamp and the high voltage level, and transmits the event packet to the networking unit 504 via the connecting device 510. When the operational device 102b transmits the event packet to the networking unit 504, the state of the GPIO pin 102b_1 remains the high voltage level. When transmission of the event packet is end, the operational device 102b changes the state of the GPIO pin 102b_1 to the low voltage level from the high voltage level. Accordingly, the signal measuring and analyzing unit 508 may obtain the receiving time and the transmission time (or packet length) of the packet received by the operational device 102b according to the changing state of the GPIO pin 102b_1.

Furthermore, the signal measuring and analyzing unit 508 may use to update the firmware of the operational device 102b. The signal measuring and analyzing unit 508 may also use to reset or turn-off the operational device 102b. According to some embodiments, the signal measuring and analyzing unit 508 may receive an instruction from Internet via the networking unit 504 to update the firmware of the operational device 102b. The signal measuring and analyzing unit 508 may update the firmware of the operational device 102b by using the bootstrap loader (BLS) function of the operational device 102b.

The networking unit 504 may receive the packet event, and transmit the packet event (i.e. Sd1) to a predetermined server. The predetermined server is arranged to save or record or analysis the packet event. Moreover, the predetermined server may transmit an instruction to the networking unit 504 for controlling the signal measuring and analyzing unit 508 update the firmware of the operational device 102b. The signal measuring and analyzing unit 508 may reset or to turn-off the operational device 102b according to the instruction received from the predetermined server.

The networking unit 504 is arranged to wirelessly transmit the first detecting event Sd1 to a processing device, i.e. the remote processing system 110.

In addition, the networking unit 504 further receives data from the signal measuring and analyzing unit 508 via the SPI and the UART, wherein the SPI is arranged to receive the instant data (e.g. the state transmitted from the signal measuring and analyzing unit 508 in every 10 ms), and the UART is arranged to receive the detecting data in relatively high speed and large volume. The data received by the networking unit 504 is stored in a memory (not shown) of the networking unit 504. Then, the networking unit 504 transmits the received data to the cloud system, i.e. the remote processing system 110. According to some embodiments, the remote processing system 110 is arranged to update the firmware of the signal measuring and analyzing unit 508 and the operational device 102b through the networking unit 504. Moreover, the remote processing system 110 is also arranged to update the firmware of the networking unit 504.

According to some embodiments, the remote processing system 110 wirelessly couples to all operational devices. The remote processing system 110 updates the firmware of the monitoring device 102 and the operational device 102b for testing the monitoring device 102 and the operational device 102b under different conditions. According to some embodiments, the remote processing system 110 uses the bootloader designed inside the networking unit 504 to update the firmware of the signal measuring and analyzing unit 508 and the operational device 102b. The remote processing system 110 may simulate the operation of the mesh network system 100 according to different number of operational devices and monitoring devices and/or different version of firmware.

The remote processing system 110 may be a cloud management platform for managing the operational devices 102a˜102p and the monitoring devices 102, 104, 106, and 108. For example, the remote processing system 110 is arranged to manage the registration, setting, firmware updating, information acquiring (e.g. address, id, setting of operational devices), resetting the operational devices, and setting of the pins connected to the operational devices.

According to some embodiments, the remote processing system 110 is arranged to acquire the occurrence time of the events and the contents of the transmitted and received packets, and to analysis the transmission paths of the packets in the mesh network system 100.

In addition, the remote processing system 110 is arranged to evaluate the maximum loading of the mesh network system 100, the maximum tolerable number of the operational devices, and the frequency of defection of an operational device. The remote processing system 110 is also arranged to determine the message storm or the abnormal operation (e.g. insufficient of memory, packet loss, or reboot unexpectedly) in the operational devices, the average processing time of a packet in an operational device, and the packet size.

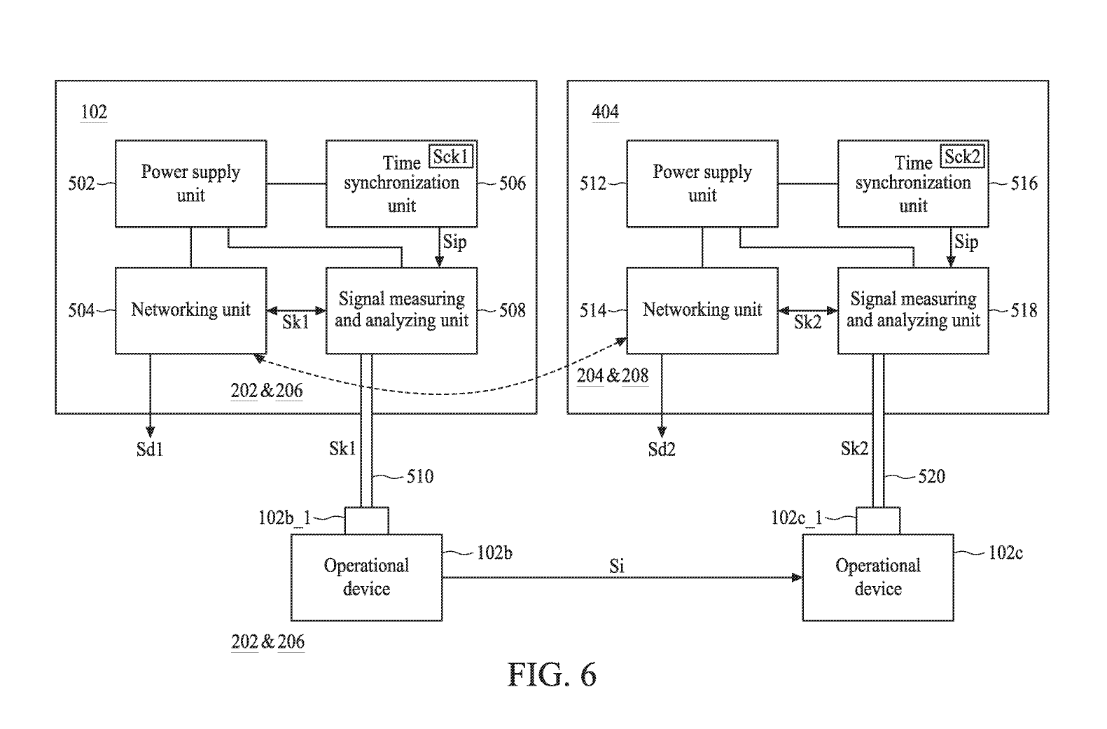

FIG. 6 is a diagram illustrating the operation of two monitoring devices (e.g. the monitoring devices 102 and 104) in accordance with some embodiments. For the purpose of description, the operational device 102b and the operational device 102c are also shown in FIG. 6. The monitoring device 102 and the monitoring device 104 are arranged to monitor the operation of the operational device 102b and the operational device 102c respectively. The monitoring device 104 comprises a power supply unit 512, a networking unit 514, a time synchronization unit 516, a signal measuring and analyzing unit 518, and a connecting device 520. The operational device 102c also comprises a GPIO pin 102c_1.

The power supply unit 512 is arranged to supply power to the operational device 102c, the networking unit 514, the time synchronization unit 516, and the signal measuring and analyzing unit 518. The networking unit 514 is arranged to wirelessly transmit the second detecting event Sd2 to the remote processing system 110. The time synchronization unit 516 is arranged to generate the clock signal Sck2. The signal measuring and analyzing unit 518 is coupled to the operational device 102c for analyzing an acknowledgement signal Sk2 received from the operational device 102c to obtain the time t4 at which the operational device 102c receiving the instruction signal Si. The connecting device 520 is coupled between the signal measuring and analyzing unit 518 and the operational device 102c. The signal measuring and analyzing unit 518 further uses the second clock signal Sck2 to lock or phase-lock the acknowledgement signal Sk2 in order to receive the acknowledgement signal Sk2. As the operation of the monitoring device 104 is similar to the monitoring device 104, the detailed description is omitted here for brevity.

Please refer to FIG. 2 and FIG. 6, the packet 202 and the corresponding timestamp 206 are transmitted by the networking unit 504 of the monitoring device 102 at time ta and time tb respectively. When the packet 204 and the corresponding timestamp 208 are received by the networking unit 514 of the monitoring device 104 at time tc and time td respectively. The signal measuring and analyzing unit 518 is arranged to read the information of the timestamp 208 to calculate the offset between the beacon receiving time of the monitoring device 102 and the beacon receiving time of the monitoring device 104. The offset may be transmitted to the monitoring device 102 from the monitoring device 104. Then, the time synchronization unit 506 and the time synchronization unit 516 adjust the phases of the clock signal Sck1 and the clock signal Sck2, respectively, based on the offset. Accordingly, the clock signal Sck1 may synchronize with the clock signal Sck2.

Please refer to FIG. 3 and FIG. 6, at time t3, when the predetermined function of the operational device 102b works, the instruction signal Si is transmitted from the operational device 102b to the operational device 102c. Meanwhile, the acknowledgement signal Sk1 is transmitted to the signal measuring and analyzing unit 508 via the connecting device 510. The signal measuring and analyzing unit 508 is arranged to analyze the acknowledgement signal Sk1 to obtain the time t3 at which the operational device 102b transmitting the instruction signal Si occurs. In addition, the networking unit 504 of the monitoring device 102 is further arranged to transmit the first detecting event Sd1 including the information of times t1, t2, and t3 to the remote processing system 110.

At time t4, when the instruction signal Si is received by the operational device 102c, the acknowledgement signal Sk2 is transmitted to the signal measuring and analyzing unit 518 via the connecting device 520. The signal measuring and analyzing unit 518 is arranged to analyze the acknowledgement signal Sk2 to obtain the time t4 at which the operational device 102c receiving the instruction signal Si occurs. In addition, the networking unit 514 of the monitoring device 104 is further arranged to transmit the second detecting event Sd2 including the information of times t4, t5, t6, and t7 to the remote processing system 110.

Accordingly, the clock signal Sck1 may synchronize with the clock signal Sck2 based on the offset between the beacon receiving time of the monitoring device 102 and the beacon receiving time of the monitoring device 104. The monitoring device 102 and the monitoring device 104 may effectively monitor the operation of the operational device 102b and the operational device 102c respectively.

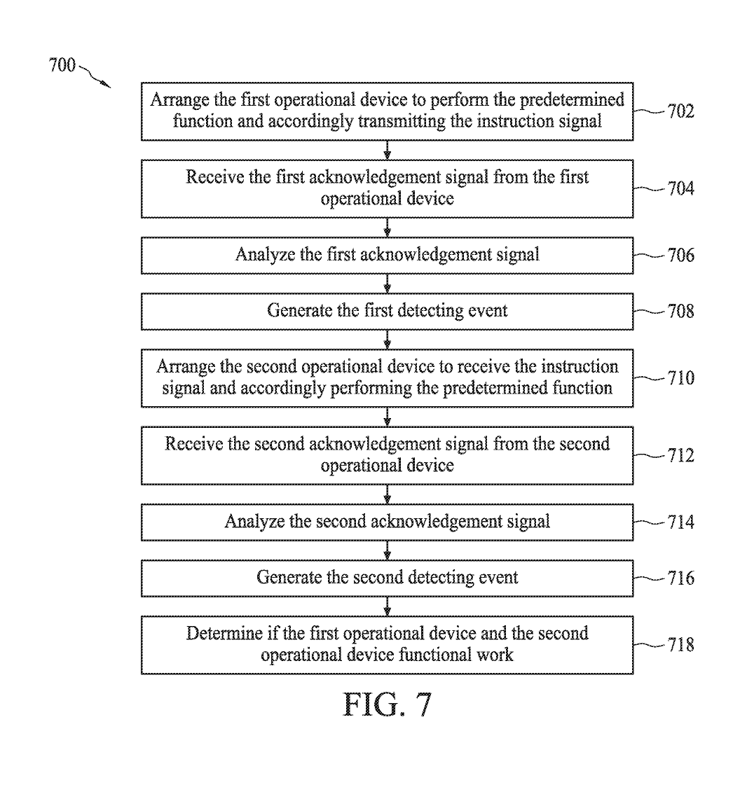

Briefly, the method of monitoring the operation of the operational device 102b and 102c may be summarized into the steps in FIG. 7. FIG. 7 is a flowchart illustrating a monitoring method 700 in accordance with some embodiment. In operation 702, arranging the operational device 102d to perform the predetermined function and accordingly transmitting the instruction signal Si. In operation 704, receiving the first acknowledgement signal Sk1 from the operational device 102b, wherein the first acknowledgement signal Sk1 indicates the operational device 102b transmitting the instruction signal Si occurs. In operation 706, analyzing the first acknowledgement signal Sk1 to obtain the time t3 at which the operational device 102b transmitting the instruction signal Si occurs. In operation 708, generating the first detecting event Sd1 based on the time t3. In operation 710, arranging the operational device 102c to receive the instruction signal Si and accordingly performing the predetermined function. In operation 712, receiving the second acknowledgement signal Sk2 from the operational device 102c, wherein the second acknowledgement signal Sk2 indicates the operational device 102c receiving the instruction signal Si occurs. In operation 714, analyzing the second acknowledgement signal Sk2 to obtain the time t4 at which the second operational device receiving the instruction signal Si occurs. In operation 716, generating the second detecting event Sd2 based on time t4. In operation 718, using the first detecting event Sd1 and the second detecting event Sd2 to determine if the first operational device 102b and the second operational device 102c functional work.

According to the description of the above embodiments, the number of the operational devices may be expanded to a relatively huge number in a large-scale field because the operation of the operational devices may be automatically monitored by a plurality of monitoring devices, wherein the monitoring devices are time-synchronized with each other. When the monitoring devices are time-synchronized with each other, the monitoring devices may precisely track the instruction signal transmitted in the operational devices, and accordingly determine the operation of the operational devices.

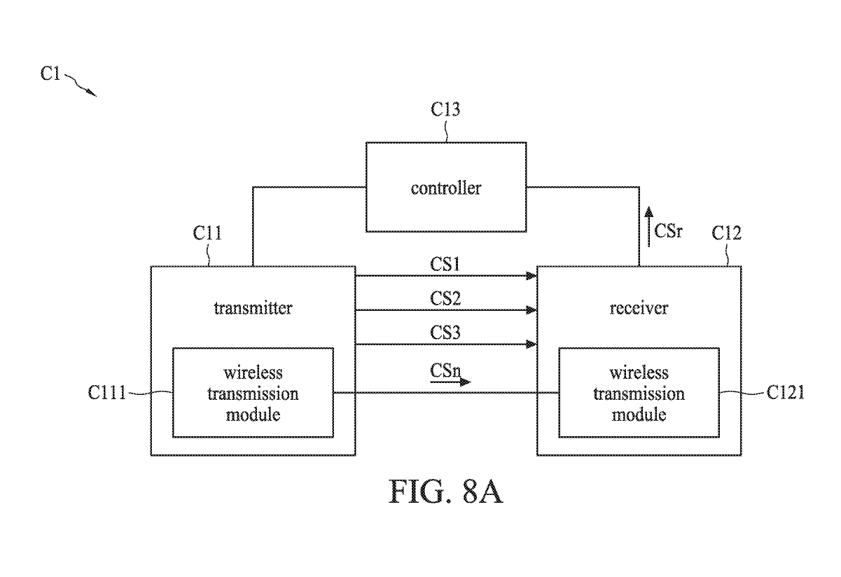

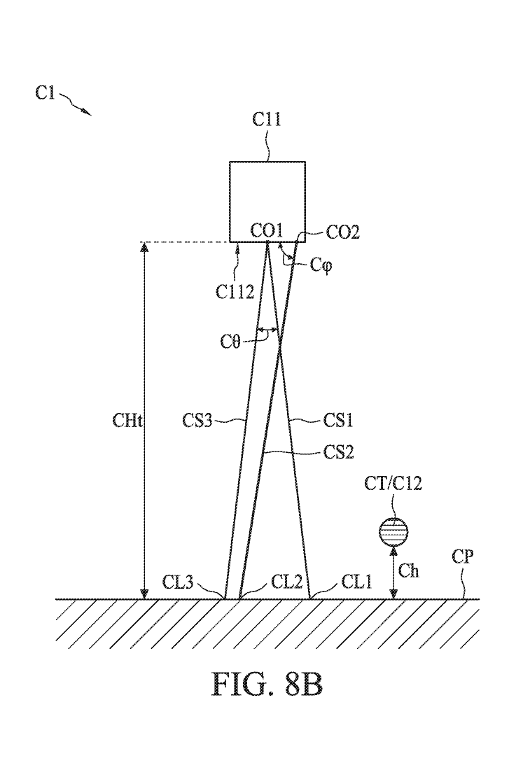

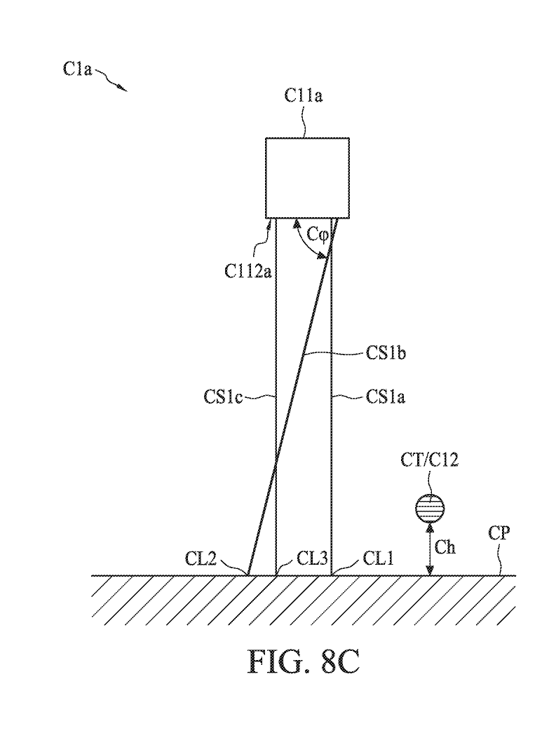

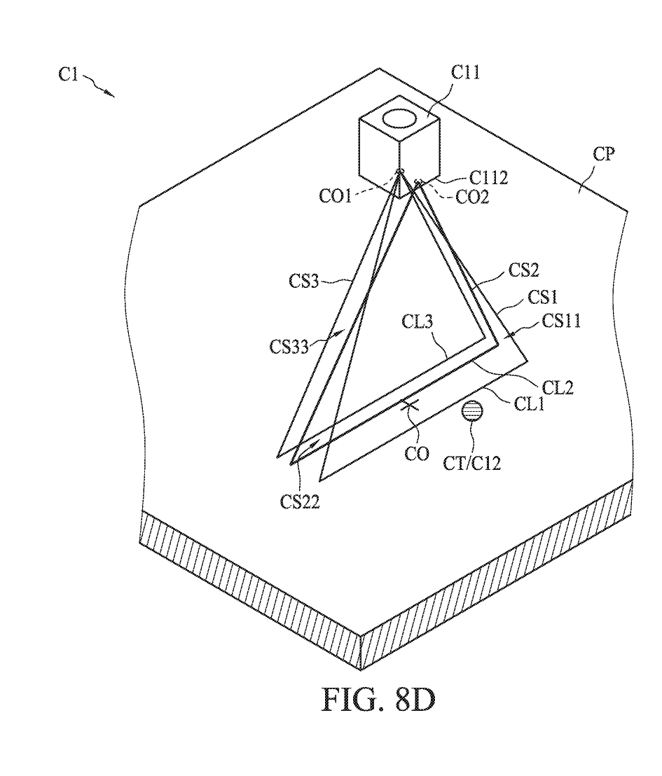

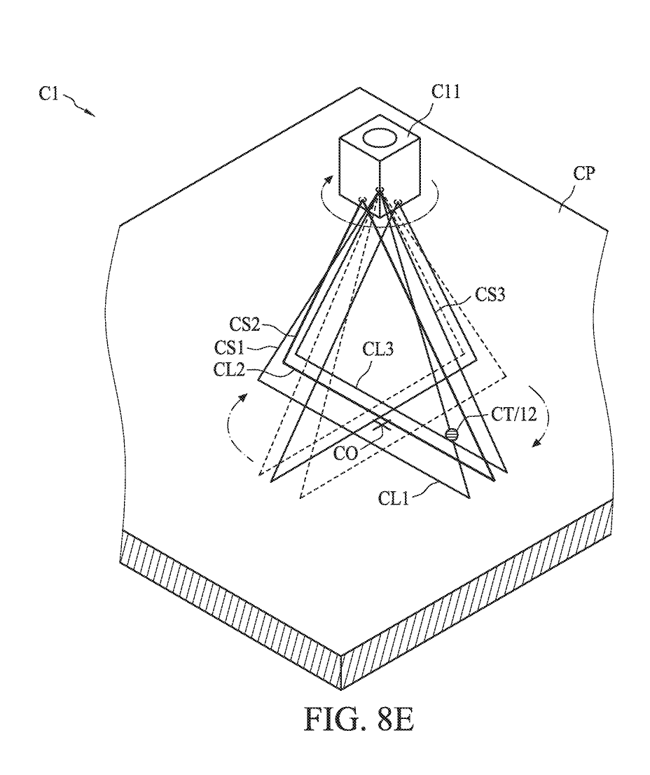

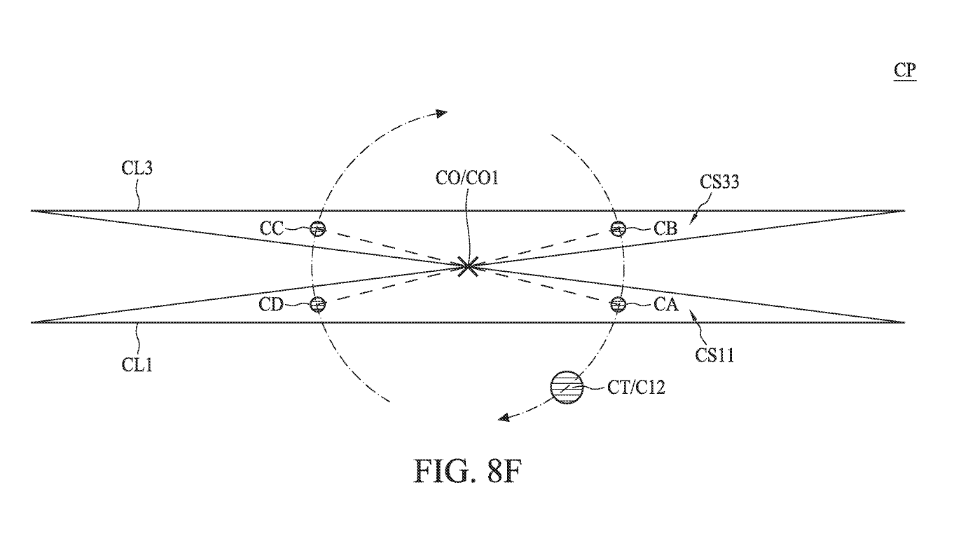

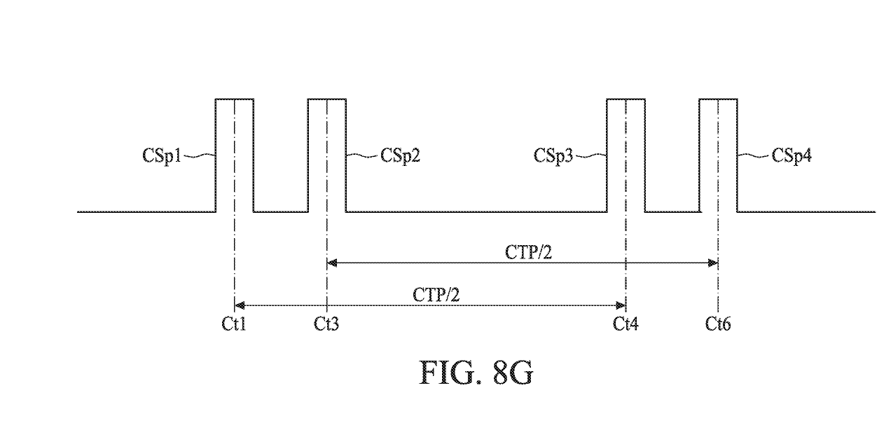

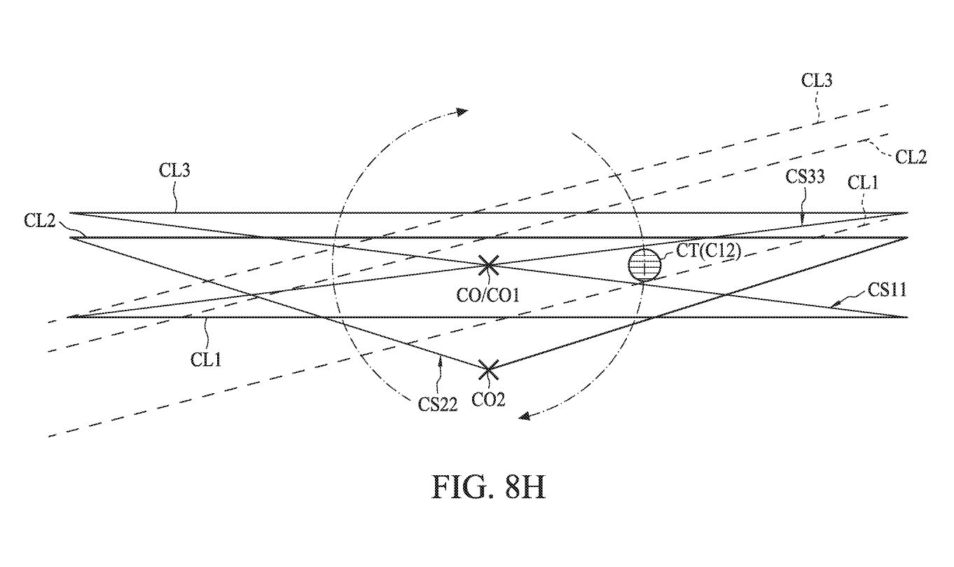

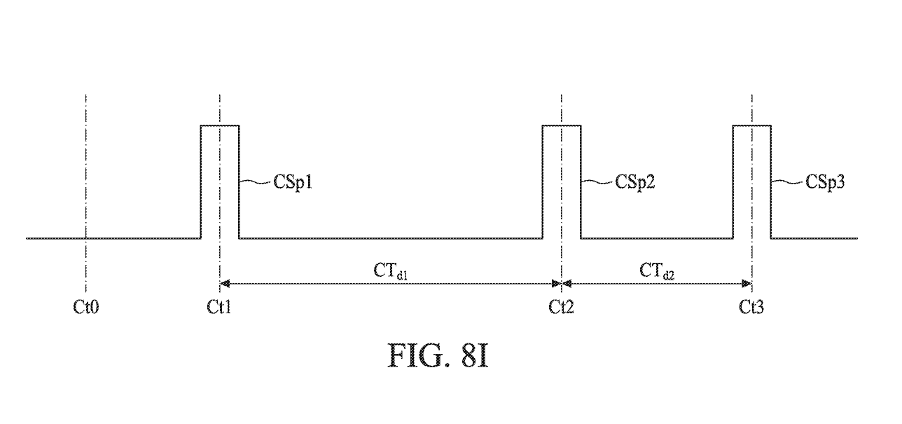

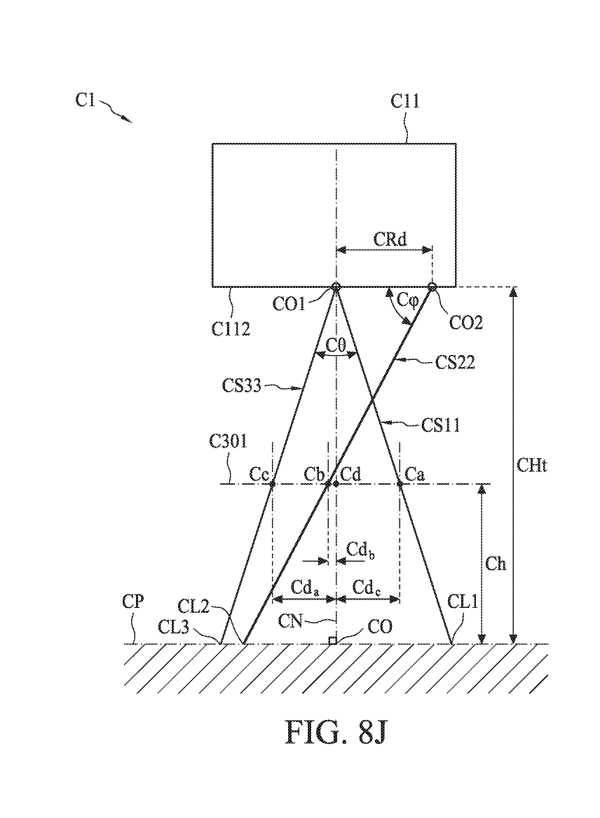

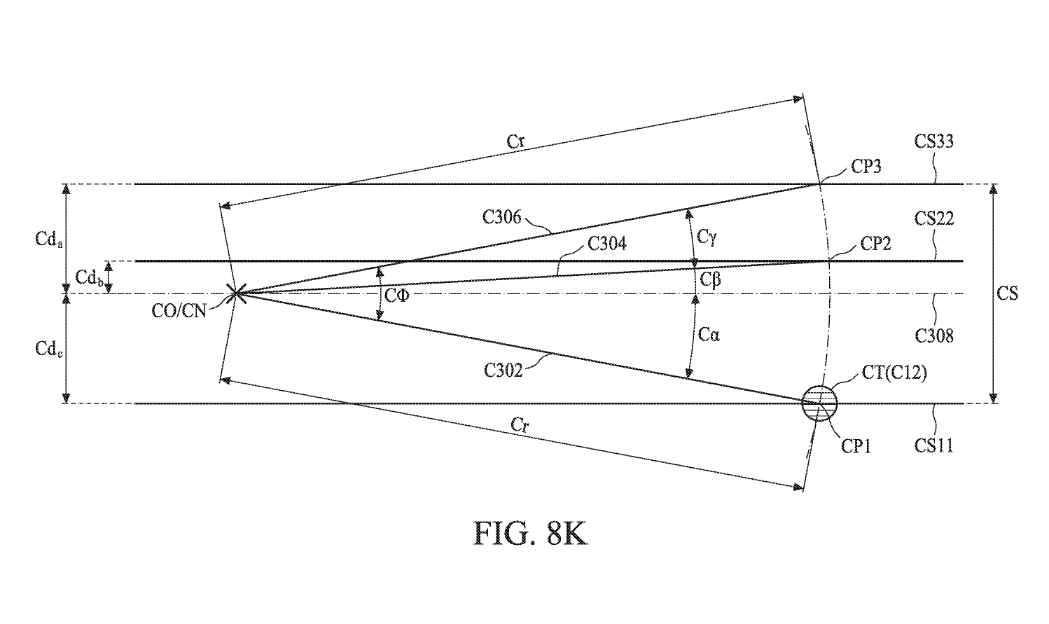

Please refer to FIG. 8A, which is a schematic view showing a coordinate sensing device according to an embodiment of the present invention. The coordinate sensing device C1 includes a transmitter C11, a receiver C12 and a controller C13. The transmitter C11 is configured to generate a first light signal CS1, a second light signal CS2 and a third light signal CS3. The receiver C12 is configured to sense the first light signal CS1, the second light signal CS2 and the third light signal CS3 for generating a receiving signal CSr. In an embodiment, the receiver C12 uses a photodiode to sense the first light signal CS1, the second light signal CS2 and the third light signal CS3, and convert the first light signal CS1, the second light signal CS2 and the third light signal CS3 into an electrical signal, for example, the receiving signal CSr. The controller C13 is configured to output a coordinate of the receiver C12 according to the receiving signal CSr. According to an embodiment of the present invention, the transmitter 12 further includes a wireless transmission module C111, and the receiver C12 also further comprises a wireless transmission module C121. The wireless transmission module C111 of the transmitter C11 is configured to transmit a wireless signal CSn to the wireless transmission module C121 of the receiver C12. The wireless signal CSn can be a pulse signal. According to one embodiment of the present invention, the wireless transmission modules C111. C121 can be implemented using the radiofrequency (RF) technology, Bluetooth technology. ZigBee technology, Wi-Fi technology, or other wireless transmission module(s). Additionally, the controller C13 is coupled with the transmitter C11 and the receiver C12. In one embodiment, the controller C13 is integrated within the transmitter C11, and the controller C13 and the receiver C12 are communicated through a wireless signal. In another embodiment, the controller C13 is integrated within the receiver C12, and the controller C13 and the transmitter C11 are communicated through a wireless signal. It is also feasible to arrange the controller C13 as a separate component, as long as it can be coupled with the transmitter C11 and the receiver C12 through a wired or wireless connection, and the present invention is not limited thereto. Therefore, the transmitter C11, the receiver C12 and controller C13 can be coupled to one another via a wired or wireless connection. Similarly, the connection among the transmitter C11, receiver C12, and controller C13 can be implemented by the radiofrequency (RF) technology. Bluetooth technology, ZigBee technology. Wi-Fi technology, or other wireless transmission module(s).

According to one embodiment of the present invention, the controller C13 may include a core control assembly of the coordinate sensing device C1; for example, it may include at least one central processing unit (CPU, e.g., a microprocessor) and a memory, or include other control hardware(s), software(s), or firmware(s). Accordingly, it is feasible to use the controller C13 to compute the three-dimensional coordinate or position between the object CT in a horizontal plane CP and the transmitter C11.

Please refer to FIG. 8B, which is a schematic view illustrating the use of a coordinate sensing device C to output a coordinate of an object CT according to one embodiment of the present invention. The object CT locates in a locale, in which the locale can be an indoor warehouse space, a marketplace space, an office space, or other kinds of indoor space. The object CT can be a personnel or an article. Moreover, to determine the coordinate of the object CT, the receiver C12 of the coordinate sensing device C1 of the present invention can be installed on the object CT. In the relevant drawings following FIG. 8B, the collection of the object CT and the receiver C12 is labeled as CT/C12. For example, when the object CT is a personnel, the receiver C12 can be disposed in a mobile device (such as, in a mobile phone or tablet) carried by the personnel. Moreover, the receiver C12 can be disposed in a coordinate sensing device worn by the personnel (such as, a smart bracelet or ring worn by the personnel). Additionally, when the object CT is an article, the receiver C12 can be disposed on the article.

The transmitter C11 of the coordinate sensing device C1 is disposed above the horizontal plane CP; that is, a horizontal level of the transmitter C11 is higher than the horizontal level of the horizontal plane CP. For example, the transmitter C11 can be installed on a ceiling, lighting fixture, smoke detector, air conditioner outlet, or other apparatuses in the locale.

According to one embodiment of the present invention, when the object CT and the receiver C12 can move freely at any height Ch between a horizontal plane CP of the locale and the transmitter C11, the controller C13 can compute the three-dimensional coordinate of the object CT in the locale.

According to one embodiment of the present invention, by the configuration of the transmitter C11 and the receiver C12, the coordinate sensing device C1 can compute the coordinate of the object CT at any height Ch between the horizontal plane CP and the transmitter C11. In other words, the coordinate is the three-dimensional coordinate in the locale.

According to one embodiment of the present invention, as illustrated in FIG. 8B, the transmitter C11 emits a first light signal CS1, a second light signal CS2 and a third light signal CS3 toward the horizontal plane CP, in which the first light signal CS1, the second light signal CS2 and the third light signal CS3 have a predetermined projection direction. In the present embodiment, the first light signal CS1, the second light signal CS2 and the third light signal CS3 respectively have a first predetermined projection direction, a second predetermined projection direction and a third predetermined projection direction, wherein the first predetermined projection direction, the second predetermined projection direction and the third predetermined projection direction are different projection directions from each other. When the first light signal CS1, the second light signal CS2 and the third light signal CS3 are projected to the horizontal plane CP of the locale according to the first predetermined projection direction, the second predetermined projection direction and the third predetermined projection direction, the surface of the horizontal plane CP will present a first straight ray pattern (straight ray pattern) CL1, a second straight ray pattern CL2 and a third straight rat pattern CL3, respectively. It should be noted that the first straight ray pattern CL1, the second straight ray pattern CL2 and the third straight ray pattern CL3 can be an invisible pattern or visible pattern on the surface of the horizontal plane CP. According to one embodiment of the present invention, the transmitter C11 can be a laser transmitter, which may emit three laser beams in different directions; the laser beams can be infrared (IR) laser beams, or the laser beams can be laser walls, while the first light signal CS1, the second light signal CS2 and the third light signal CS3 can be a first laser wall, a second laser wall and a third laser wall, respectively. It should be noted that the laser wall is a plane formed by beams.

According to the embodiment shown in FIG. 8B, there is a predetermined angle Cθ between the laser wall of the first light signal CS1 and the laser wall of the third light signal CS3, and there is another predetermined angle Cφ between the laser wall of the second light signal CS2 and a bottom surface of the transmitter C11. On the horizontal plane CP, the first straight ray pattern CL1, the second straight ray pattern CL2 and the third straight ray pattern CL3 are substantially three parallel straight ray patterns, wherein the second straight ray pattern CL2 is disposed between the first straight ray pattern CL1 and the third straight ray pattern CL3. In addition, in the present embodiment, since the distance CHt between the horizontal plane CP and the transmitter C11 and the angles Cθ and Cφ are predetermined, the respective distances between the first straight ray pattern CL, the second straight ray pattern CL2 and the third straight ray pattern CL3 are three predetermined distances.

Moreover, in the present embodiment, a bottom surface C112 of the transmitter C11 has a first transmitting terminal CO1 and a second transmitting terminal CO2, wherein the first transmitting terminal CO1 is configured to output the first light signal CS1 and the third light signal CS3, the second transmitting terminal CO2 is configured to output the second light signal CS2, and the distance between the first transmitting terminal CO1 and the second transmitting terminal CO2 is a predetermined distance. In the present embodiment, the bottom surface C112 faces the horizontal plane CP, and the bottom surface C112 is parallel to the horizontal plane CP.

It should be noted that in another embodiment of the present invention, the first light signal CS1 and the third light signal CS3 also may have the same projection direction. For example, the first light signal CS1 is substantially parallel to the third light signal CS3 as shown in FIG. 8C which is a schematic view illustrating a coordinate of the object CT computed by the coordinate sensing device C1a of the present invention. As shown in FIG. 8C, the transmitter C11a may emit three infrared laser beams S1a, S1b and S1c, wherein the first infrared laser beam S1a is substantially parallel to the third infrared laser beam S1c, and the second infrared laser beam S1b is not parallel to the infrared laser beams S1a, S1b. In the present embodiment, there is a predetermined angle Cφ between the laser wall of the second infrared laser beam S1b and a bottom surface C112a of the transmitter C11a. Accordingly, the present invention is not limited to any particular aspect of the lights emitted by the transmitter C11a. As long as the respective predetermined angles between the infrared laser beams S1a, S1b. S1c and the bottom surface C112a of the transmitter C11a and the distance between the transmitter C11a and the horizontal plane CP (i.e., the height in the z-axis) are known, it is still feasible to compute the distances between the first straight ray pattern CL1, the second straight ray pattern CL2 and the third straight ray pattern CL3 on the horizontal plane CP.

FIG. 8D is a schematic view illustrating the use of a coordinate sensing device C of the present invention to output a coordinate of an object CT according to another embodiment. The embodiment shown in FIG. 8D is the same as the embodiment shown in FIG. 8B. As shown in FIG. 8D, the transmitter C11 emits the first light signal CS1, the second light signal CS2 and the third light signal CS3 toward the horizontal plane CP. The first light signal CS1, the second light signal CS2 and the third light signal CS3 form a first laser wall CS11, a second laser wall CS22 and a third laser wall CS33 between the transmitter C11 and the horizontal plane CP, respectively. The first laser wall CS11, the second laser wall S12 and the third laser wall S13 are three triangle planes shown in FIG. 8D, respectively. In addition, the first light signal CS1 and the third light signal CS3 are output from the first transmitting terminal CO1, and the second light signal CS2 is output from the second transmitting terminal CO2. When the first light signal CS1, the second light signal CS2 and the third light signal CS3 reach the horizontal plane CP, three parallel straight ray patterns are formed on the horizontal plane CP (that is the first straight ray pattern CL, the second straight ray pattern CL2 and the third straight ray pattern CL3). According to one embodiment of the present embodiment, a point on the horizontal plane CP that is right below the transmitter C11 is defined as a rotation center CO.

Please refer to FIG. 8E, which is schematic view illustrating the use of a coordinate sensing device C1 of the present invention to output a coordinate of an object CT according to another embodiment. As illustrated in FIG. 8E, during the operation of the coordinate sensing device C1, the transmitter C11 controls the first light signal CS1, the second light signal CS2 and the third light signal CS3 such that the first straight ray pattern CL1, the second straight ray pattern CL2 and the third straight ray pattern CL3 rotate about the rotation center CO. In the present embodiment, the rotation direction is clockwise; however, the present invention is not limited thereto. In another embodiment, the rotation direction can also be counterclockwise. In one embodiment, the transmitter C11 controls the first light signal CS1, the second light signal CS2 and the third light signal CS3 through a control unit (not shown in the drawings) such that the first straight ray pattern CL1. the second straight ray pattern CL2 and the third straight ray pattern CL3 rotate about the rotation center CO simultaneously, and therefore, the first laser wall CS11, the second laser wall CS22 and the third laser wall CS33 sequentially scan over (or pass through) the receiver C12 on the object CT. It should be noted that the rotation center CO of the present invention is not limited to the one on the horizontal plane CP right below the transmitter C11. In some other embodiments, the transmitter C11 itself also rotates in a different direction such that the rotation center CO on the horizontal plane CP also rotates simultaneously. Alternatively, in some other embodiments, the transmitter C11 itself does not rotate, and only the first straight ray pattern CL1, the second straight ray pattern CL2 and the third straight ray pattern CL3 rotate about the rotation center CO simultaneously.

When the first straight ray pattern CL1, the second straight ray pattern CL2 and the third straight ray pattern CL3 rotate about the rotation center CO, the first laser wall CS11, the second laser wall CS22 and the third laser wall CS33 scan over the receiver C12 on the object CT at different time points. When the first laser wall CS11 scan over the object CT, the receiver C12 on the object CT senses the light from the first laser wall CS11, and accordingly, the receiver C12 outputs a first signal at a first time point. When the second laser wall CS22 scan over the object CT, the receiver C12 on the object CT senses the light from the second laser wall CS22, and accordingly, the receiver C12 outputs a second signal at a second time point. When the third laser wall CS33 scan over the object CT, the receiver C12 on the object CT senses the light from the third laser wall CS22, and accordingly, the receiver C12 outputs a third signal at a third time point. According to one embodiment of the present invention, the first signal, the second signal and the third signal are a first pulse signal, a second pulse signal and a third pulse signal, respectively.

FIG. 8F is a top view illustrating the use of a coordinate sensing device C1 of the present invention to scan an object CT according to another embodiment. For simplicity, FIG. 8F only shows the first straight ray pattern CL1 and the third straight ray pattern CL3, and their first laser wall CS11 and the third laser wall CS33, respectively. In FIG. 8F, the rotation center CO is superimposed on the first transmitting terminal CO1, and is indicated as CO/CO1. The height Ch of the object CT is between the horizontal plane CP and the transmitting terminal CO1 When the first ray pattern CL1 and the third ray pattern CL3 rotate about the rotation center CO on the horizontal plane CP by 360 degrees, the four positions CA, CB, CC, CD on the first laser wall CS11 and the third laser wall CS33 sequentially scan over the receiver C12 on the object CT. The receiver C12 outputs four pulse signals at four corresponding time points, respectively, as illustrated in FIG. 8G. FIG. 8G is an oscillogram of a receiving signal CSr generated by a receiver C12 according to one embodiment of the present invention. The receiving signals Sr at the time points Ct1, Ct3, Ct4, Ct6 are four pulse signals CSp1, CSp2, CSp3, CSp4, respectively. According to one embodiment of the present invention, the pulse signals CSp1, CSp2 are corresponding to the positions CA, CB of the first laser wall CS11 and the third laser wall CS33, respectively, and the pulse signals CSp3, CSp4 are corresponding to the positions CC, CD of the third laser wall CS33 and the first laser wall CS11, respectively. Further, if the period of a full cycle of scanning of the first straight ray pattern CL1 and the third straight ray pattern CL3 is CTP, then the time difference between the respective central time points Ct1, Ct4 of the pulse signals CSp1, CSp3 or the time difference between the respective central time points Ct3. Ct6 of the pulse signals CSp2, CSp4 is half the scan period (CTP/2). The angular velocity ω at which the first straight ray pattern CL and the third straight ray pattern CL3 rotate on the horizontal plane CP can be calculated from formula (1):

ω=2π/CTP (1)

Accordingly, the angular velocity ω at which the first straight ray pattern CL1 and the third straight ray pattern CL3 rotate on the horizontal plane CP is a predetermined angular velocity. It should be noted that the angular velocity of the first laser wall CS11 and the third laser wall CS33 at the height Ch is the same as the angular velocity ω of the first straight ray pattern CL1 and the third straight ray pattern CL3 on the horizontal plane CP.

It should be noted that in order to avoid the issue that the noise light in the ambient environment might affect the accuracy of the receiver C12, in some embodiments, the coordinate sensing device C1, 1a can further comprise a filter (not shown in the drawings) disposed on the receiver C12, and the filter is configured to allow only the passage of the first light signal CS1, the second light signal CS2 and the third light signal CS3. By using the filter, it is possible to filter out the light other than the first light signal CS1, the second light signal CS2 and the third light signal CS3, thereby improving the detection accuracy of the receiver C12.

Please refer to FIG. 8H, which is a top view illustrating the use of a coordinate sensing device C1 to scan an object CT according to another embodiment of the present invention. As shown in FIG. 8H, when the first straight ray pattern CL1, the second straight ray pattern CL2 and the third straight ray pattern CL3 continue to rotate about the rotation center CO on the horizontal plane CP, the first laser wall CS11, the second laser wall CS22 and the third laser wall CS33 sequentially scan over the receiver C12 on the object CT. The receiver C12 can sense light from the first laser wall CS11, the second laser wall CS22 and the third laser wall CS33 for multiple times at different time points. Therefore, the receiving signal CSr generated by the receiver C12 has multiple sets of pulse signals.

Moreover, in the present embodiment, when the first laser wall CS11, the second laser wall CS22 and the third laser wall CS33 scan over the object CT, the transmitter C11 first uses the wireless transmission module C111 depicted in FIG. 8A to transmit a wireless signal CSn to the wireless transmission module C121 of the receiver C12. When the receiver C12 receives the wireless signal CSn, the receiver C12 generates a reference time Ct0. The reference time Ct0 is configured to synchronize the transmitter C11 and the receiver C12, and therefore, the wireless signal CSn can be viewed as a synchronizing signal. Furthermore, the transmitter C11 transmits the wireless signal CSn to the receiver C12 when the first straight ray pattern CL1, or the third straight ray pattern CL3 has a predetermined angle or a reference angle (such as, 0 degree), such that the receiver C12 generates a reference time (i.e., Ct0). Next, whenever the first straight ray pattern CL1 or the third straight ray pattern CL3 rotates to the predetermined angle or the reference angle, the transmitter C11 transmits the wireless signal CSn to the receiver C12, such that the receiver C12 generates a reference time (i.e., Ct0). In this way, the transmitter C11 and the receiver C12 are synchronized. FIG. 8I is an oscillogram of a receiving signal CSr generated by a receiver C12 according to another embodiment of the present invention. The receiving signals Sr, at the time points Ct1, Ct2, Ct3, are three pulse signals CSp1, CSp2, CSp3, respectively; the pulse signals CSp1, CSp2, CSp3 correspond to the positions of the object CT scanned by the first laser wall CS11, the second laser wall CS22 and the third laser wall CS33, respectively. According to one embodiment of the present invention, the receiver C12 receives the wireless signal CSn from the transmitter C11 at the reference time Ct0. Further, the receiving signal CSr generated by the receiver C12 is received and stored by the controller C13.

Moreover, there is a time interval (or time difference) CT_{d1} between the first time Ct1 and the second time Ct2, and the time interval CT_{d1} is the time difference between the central time points of the pulse signals CSp1, CSp2; that is. CT_{d1}=Ct2−Ct1. There is a time interval (or time difference) CT_{d2} between the second time Ct2 and the third time Ct3, and the time interval CT_{d2} is the time difference between the central time points of the pulse signals CSp2, CSp3; that is, CT_{d2}=Ct3−Ct2.

It should be noted that, when implementing this embodiment, a microprocessor within the controller C13 can record the time points of the rising and falling edges of three consecutive pulse signals (CS1, CS2 and CS3) so that it can further compute the central time points of the two pulse signals, thereby obtaining a more accurate time difference.

Moreover, a mean value of the first time Ct1 and the third time Ct3 can be calculated; the mean value is (Ct1+Ct3)/2. A time difference between the mean value and the reference time Ct0 is (Ct1+Ct3)/2−Ct0; i.e. the time required for the first laser wall CS11 or the third laser wall CS33 to rotate from the reference angle to the receiver C12 of the object CT. Furthermore, a rotation angle ψ can be calculated by multiplying the time difference between the mean value (i.e., (Ct1+Ct3)/2) and the reference time Ct0 by the angular velocity ω, referring to the following formula (2):

Ψ=ω*((Ct1+Ct3)/2−Ct0) (2)

Generally, the rotation angle ψ is the angle of the first laser wall CS11 or the third laser wall CS33 rotating from a reference point to the object CT. According to one embodiment of the present invention, the controller C13 uses the above-mentioned rotation angle ψ to compute the three-dimensional coordinate of the object CT at the height Ch.

FIG. 8J is a top view illustrating the use of the coordinate sensing device C1 of the present invention to compute the three-dimensional coordinate according to one embodiment. In FIG. 8J, the vertical height of the object CT (or the receiver C12) from the horizontal plane CP is h. In addition, on a horizontal line C301 of the height Ch, the second laser wall CS22 is formed between the first laser wall CS11 and the third laser wall CS33. A normal line CN perpendicular to the horizontal plane CP and passing through the rotation center CO is aligned with the first transmitting terminal CO1 of the bottom surface C112 of the transmitter C11, i.e. the normal line CN passing through the first transmitting terminal CO1. The second laser wall CS22 is emitted from the second transmitting terminal CO2, and the second transmitting terminal CO2 is offset from the normal line CN. Further, the three laser walls CS11, CS22. CS33 rotate about the rotation center CO at the angular velocity ω(ω=2π/CTP). The vertical or the shortest distance between the transmitter C11 and the horizontal plane CP is CHt. Similar to FIG. 8B, there is an angle Cθ between the first laser wall CS11 and the third laser wall CS33, which is a predetermined angle. There is a predetermined distance CRd between the first transmitting terminal CO1 and the second transmitting terminal CO2 of the bottom surface C112 of the transmitter C11, and there is an angle Cφ between the second laser wall CS22 and the bottom surface C112, which is a predetermined angle.

Additionally, on the horizontal line C301 of the height Ch, the first laser light wall CS11 intersects the horizontal line C301 at the point Ca, the second laser wall CS22 intersects the horizontal line C301 at the point Cb, the third laser wall CS33 intersects the horizontal line C301 at the point Cc, and the normal line CN intersects the horizontal line C301 at the point Cd. On the horizontal line C301, the straight line distance between the point Cd and the point Cc is Cdₐ, the straight line distance between the point Cb and the point Cd is Cd_{b}, and the straight line distance between the point Ca and the point Cd is Cd_{c}. It should be noted that these straight line distances Cdₐ, Cd_{b}, Cd_{c} will change along with the variation of the height Ch of the object CT.

Please refer to FIG. 8K, which is a top view illustrating the use the coordinate sensing device C1 to scan an object CT according to one embodiment of the present invention. As illustrated in FIG. 8K, in the present embodiment, there is a distance Cr between the normal line CN passing through the rotation center CO and the object CT, when viewed from the top, and the position at which the first laser wall CS11 rotates and passes through the object CT is a first point position CP1. Meanwhile, for the second laser wall CS22, there is a second point position CP2 that is spaced from the normal line CN passing through the rotation center CO by the same distance Cr; and for the third laser wall CS33, there is a third point position CP3 that is spaced from the normal line CN passing through the rotation center CO by the same distance Cr. In this case, the first point position CP1 and the normal line CN form a first straight line C302, the second point position CP2 and the normal line CN form a second straight line C304, the third point position CP3 and the normal line CN form a third straight line C306, and there is a fourth straight line C308 in the middle between the first laser wall CS11 and the third laser wall CS33. The fourth straight line C308 is parallel to the first laser wall CS11 or the third laser wall CS33. The first straight line C302 and the third straight line C306 have an included angle CΦ therebetween, the first straight line C302 and the fourth straight line C308 have an included angle Cα therebetween, the fourth straight line C308 and the second straight line C304 have an included angle CP therebetween, and the second straight line C304 and the third straight line C306 have an included angle Cγ therebetween. In the present embodiment, the included angle CΦ is equal to the sum of the included angles Cα, Cβ and Cγ. In addition, the included angle Cα is substantially a half of the included angle CΦ. Since the first straight ray pattern CL1 and the second straight ray pattern CL2 have the predetermined angular velocity ω when they rotate about the rotation center CO, the above-mentioned included angle Cα would equal to the product of the predetermined angular velocity ω multiplying the mean value of the first time interval CT_{d1} and the second time interval CT_{d2}, referring to the following formula (3):

Cα=ω*(CT_{d1}+CT_{d2})/2 (3)

In addition, at the height Ch, there is a distance CS between the first laser wall CS11 and the third laser wall CS33 (the distance CS changes along with the variation of the height Ch in the present embodiment).

As illustrated in FIG. 8J and FIG. 8K, the first straight line distance Cdₐ is equal to the third straight line distance Cd_{c}, referring to the following formula (4):

Cd_{c}=Cdₐ=(CHt−Ch)*tan(Cθ/2) (4)

The second straight line distance Cd_{b} satisfies the following formula (5):

Cd_{b}=(CHt−Ch)*cot(Cφ)−CRd (5)

Further, the following formulas (6), (7), (8), (9) and (10) can be derived from FIG. 8J and FIG. 8K:

sin Cα=CS/2Cr=Cd_{c}/Cr (6)

Sin Cβ=Cd_{b}/Cr (7)

Cγ=Cα−Cβ (8)

CT_{d1}=(Cα+Cβ)/ω (9)

CT_{d2}=(Cα−Cβ)/ω (10)

According to the above formulas, the controller C13 can compute the values of the straight line distance Cr and the height Ch in light of the following formulas (11) and (12):

$$\begin{matrix} {Cd}_{c} = Cr * sin ( ω * ( \frac{{CT}_{d 1} + {CT}_{d 2}}{2} ) = ( CHt - Ch ) * tan ( \frac{C θ}{2} ) & ( 11 ) \\ {Cd}_{b} = Cr * sin ( ω * ( \frac{{CT}_{d 1} + {CT}_{d 2}}{2} ) = ( CHt - Ch ) * cot ( C ϕ ) - {CR}_{d} & ( 12 )\end{matrix}$$

The angular velocity ω, the first time interval CT_{d1} and the second time interval CT_{d2} can be obtained from measurement and computation. The height CHt (i.e., the distance between the transmitter C11 and the horizontal plane CP), the included angle Cθ, the included angle Cφ and the predetermined distance CRd are known parameters. Therefore the height Ch of the object CT and the distance Cr can be computed by the controller C13 according to the above formulas (11) and (12), and are combined with the rotation angle Ψ obtained from the above formula (2), thereby obtaining the three-dimensional coordinate (x,y,z) of the object CT in the locale, illustrated in the following formula:

x=Cr*cos(ψ),y=Cr*sin(ψ),z=Ch (13)

x represents an x-coordinate distance of the object CT at the height Ch, y represents a y-coordinate distance of the object CT at the height Ch, z represents a height of the object CT spaced from the horizontal plane CP, and Ψ represents the rotation angle.

Based on the above illustrations, the three-dimensional coordinate (x,y,z) of the object CT in the locale can be computed by the microprocessor in the controller C13 according to the angular velocity ω at which the first light signal CS1, the second light signal CS2 and the third light signal CS3 rotate (or the angular velocity ω at which the first laser wall CS11, the second laser wall CS22 and the third laser wall CS33 rotate), the distance between the transmitter C11 and the horizontal plane CP (i.e., CHt), the first time interval CT_{d1}, the second time interval CT_{d2} and the reference time Ct0. Accordingly, the exact position of an object CT in a specific locale can be accurately obtained by the embodiment of the present invention.

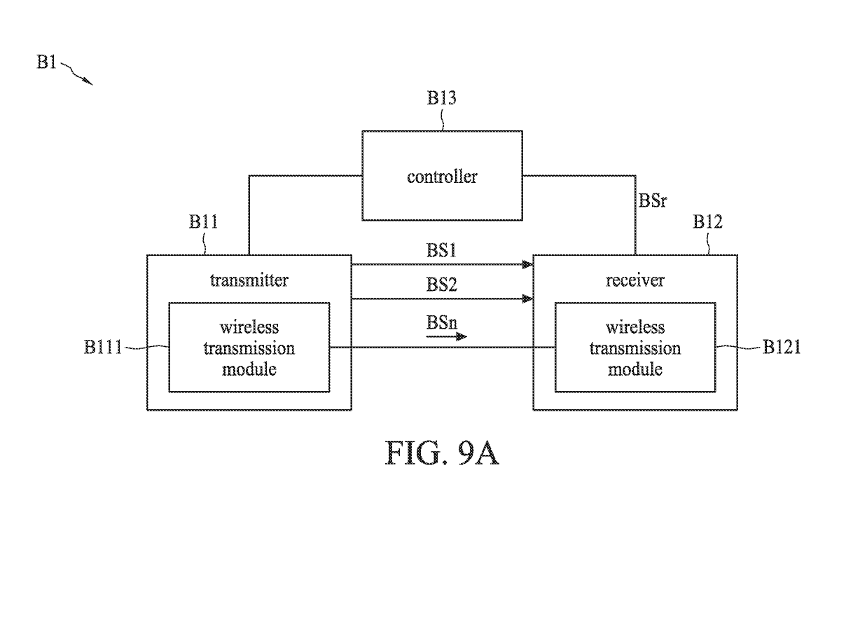

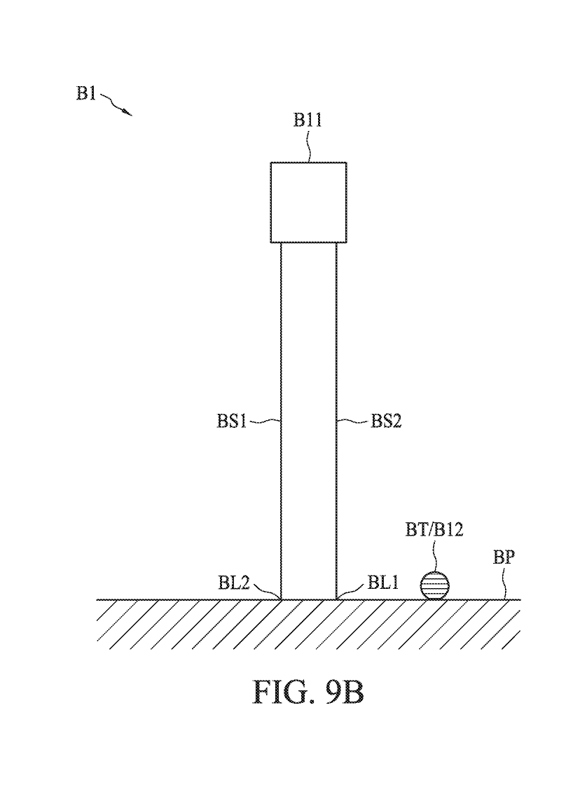

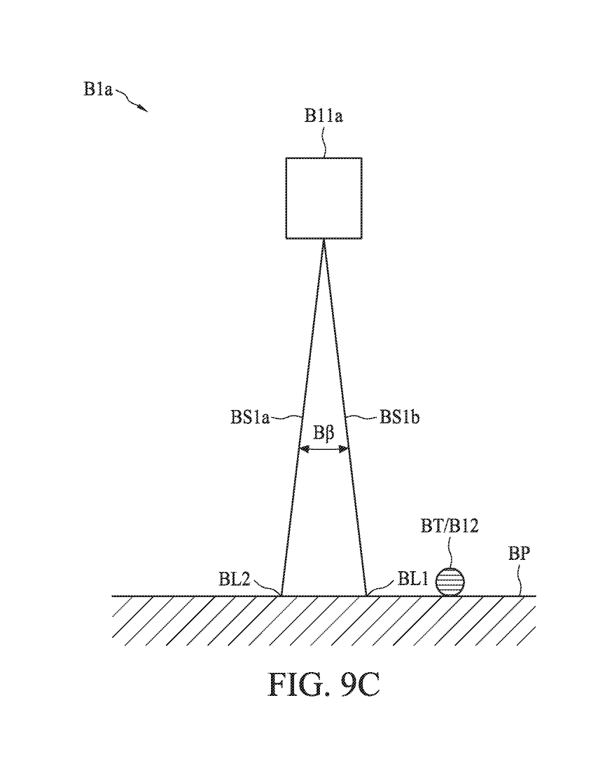

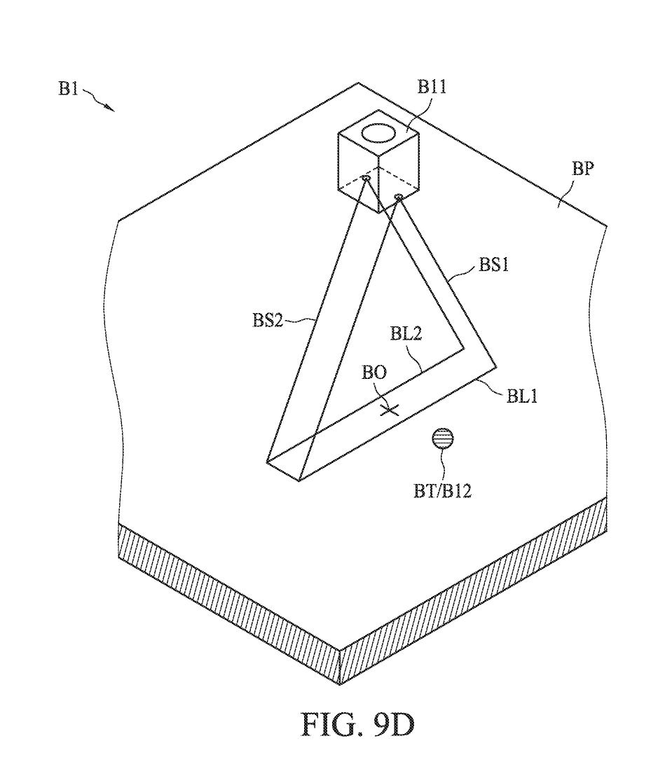

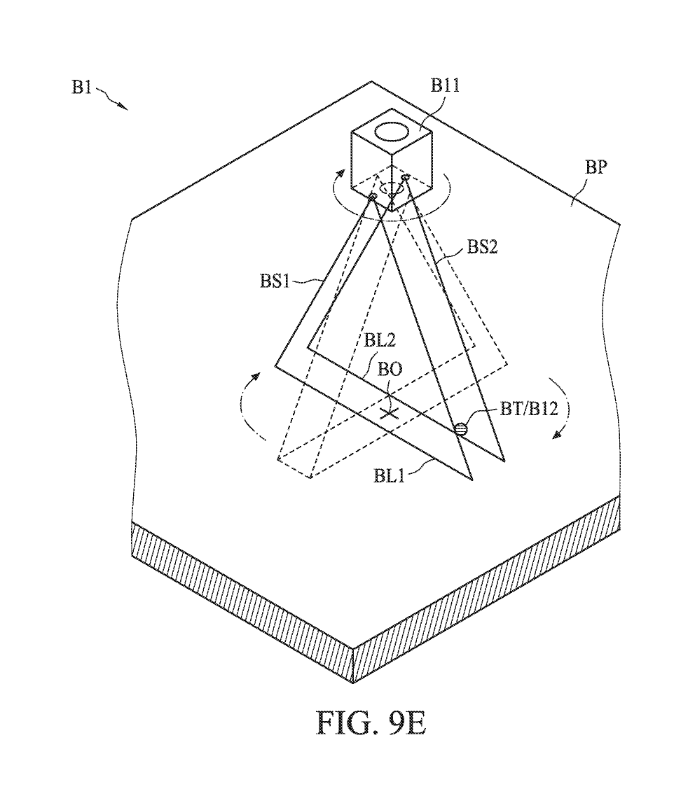

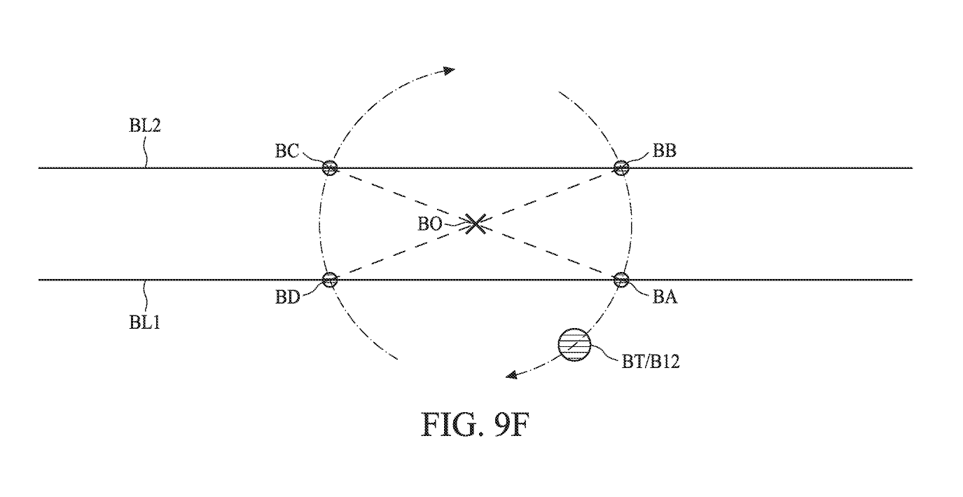

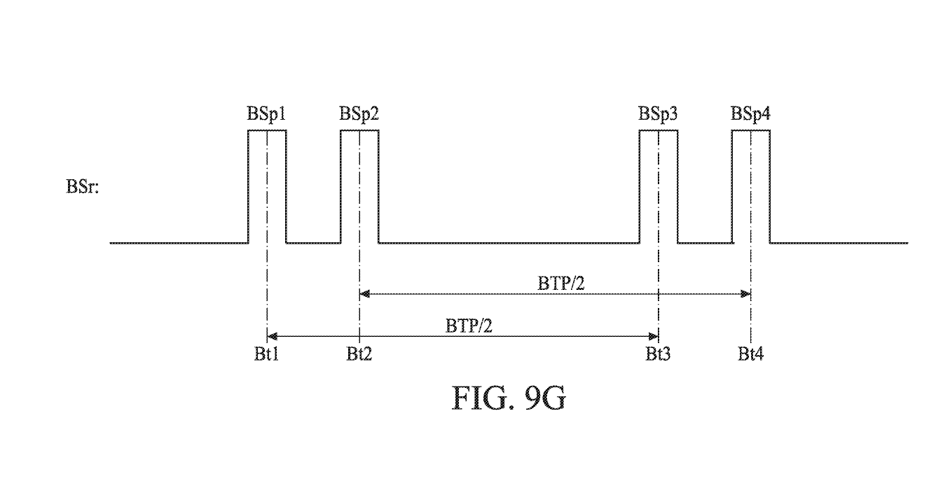

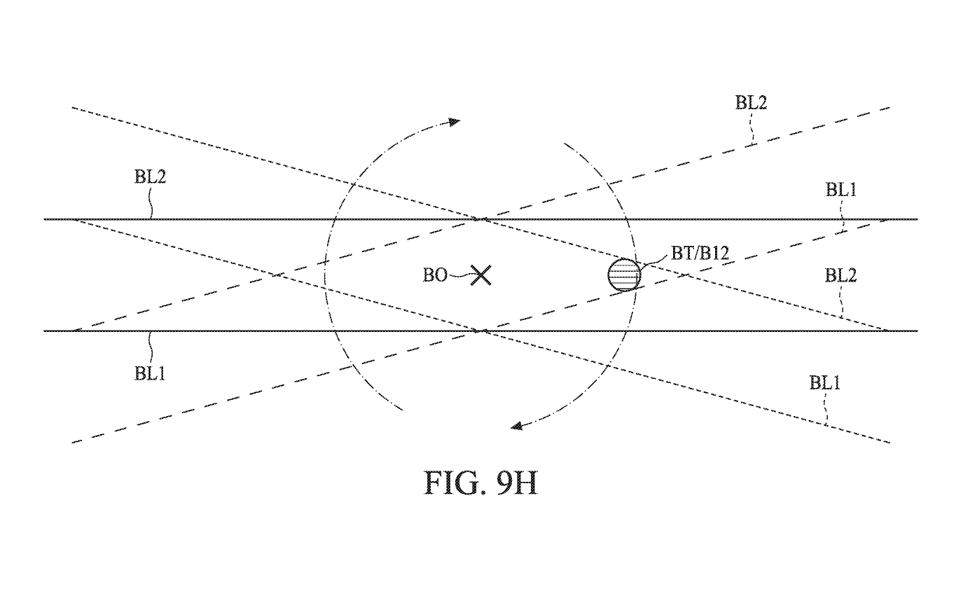

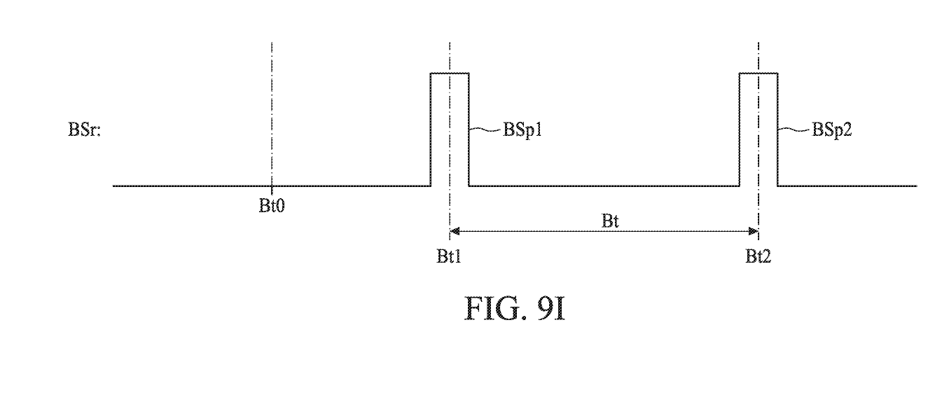

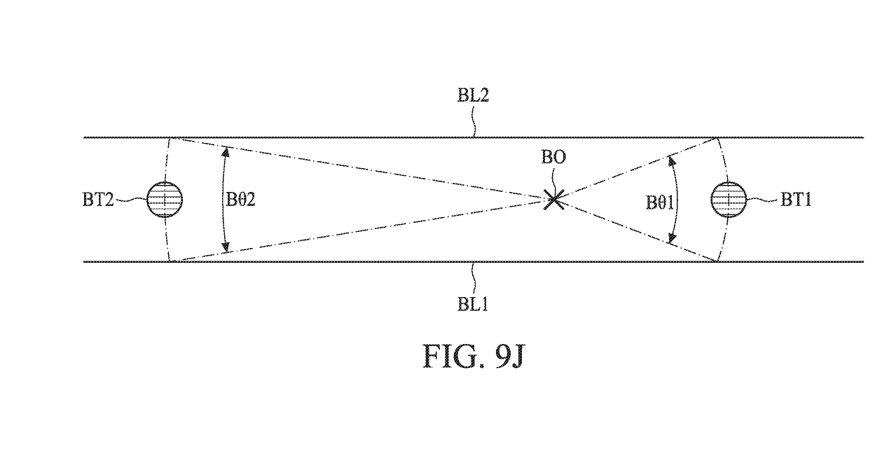

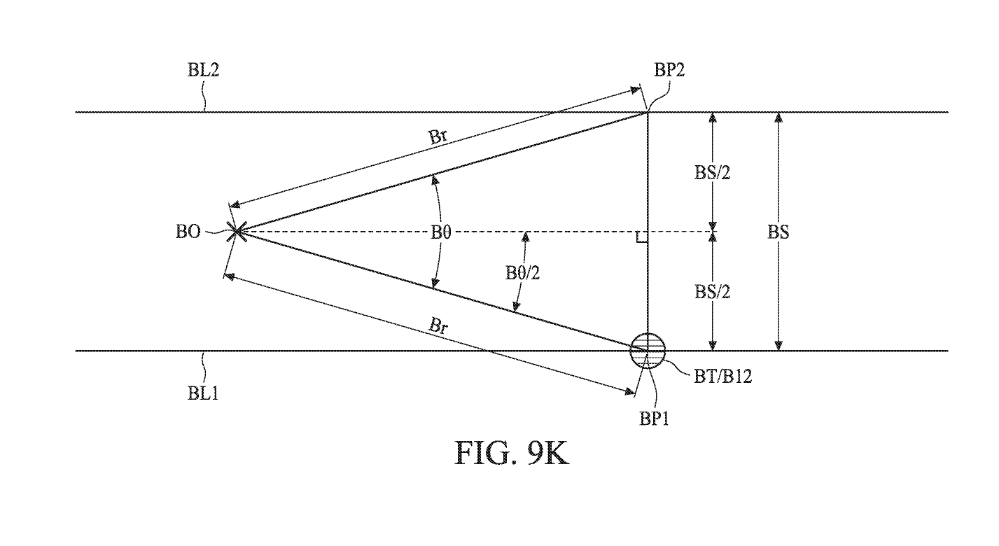

Referring to FIG. 9A, which is a schematic view illustrating a coordinate sensing device B1 according to one embodiment of the present invention. The coordinate sensing device B1 comprises a transmitter B11, a receiver B12, and a controller B13. The transmitter B11 is configured to generate a first light signal BS1 and a second light signal BS2. The receiver B12 is configured to sense the first light signal BS1 and the second light signal BS2, so as to generate a receiving signal BSr. In one embodiment, the receiver B12 uses a photodiode to detect the first light signal BS1 and the second light signal BS2, and convert the first light signal BS1 and the second light signal BS2 into an electric signal, such as the receiving signal BSr. The controller B13 is configured to output a coordinate of the receiver B12 according to the receiving signal BSr. According to one embodiment of the present invention, the transmitter B11 further comprises a wireless transmission module B111, whereas the receiver B12 also further comprises a wireless transmission module B121. The wireless transmission module B111 of the transmitter B11 is configured to transmit a wireless signal BSn to the wireless transmission module B121 of the receiver B12. The wireless signal BSn can be a pulse signal. According to one embodiment of the present invention, the wireless transmission modules B111, B121 can be implemented using the radiofrequency (RF) technology, Bluetooth technology, ZigBee technology, Wi-Fi technology, or other wireless transmission module(s). Additionally, the controller B13 is coupled with the transmitter B11 and the receiver B12. In one embodiment, the controller B13 is integrated within the transmitter B11, whereas the controller B13 and the receiver B12 are communicated through a wireless signal. In another embodiment, the controller B13 is integrated within the receiver B12, whereas the controller B13 and the transmitter B11 are communicated through a wireless signal. It is also feasible to arrange the controller B13 as a separate member, as long as it can be coupled with the transmitter B11 and the receiver B12 through a wired or wireless connection, and the present invention is not limited thereto. Therefore, the transmitter B11, the receiver B12 and controller B13 can be coupled to one another via a wired or wireless connection. Similarly, the connection among the transmitter B11, receiver B12, and controller B13 can be implemented by the radiofrequency (RF) technology, Bluetooth technology, ZigBee technology, Wi-Fi technology, or other wireless transmission module(s).

According to one embodiment of the present invention, the controller B13 may comprise a core control assembly of the coordinate sensing device B1; for example, it may comprise at least one central processing unit (CPU, e.g., a microprocessor) and a memory, or comprises other control hardware(s), software(s), or firmware(s). Accordingly, it is feasible to use the controller B13 to compute the two-dimensional or three-dimensional position of the object BT in a horizontal plane BP.

Referring to FIG. 9B, which is a schematic view illustrating the use of a coordinate sensing device B1 of the present invention to output a coordinate of an object BT according to one embodiment. The object BT locates in a locale, in which the locale can be an indoor warehouse space, a marketplace space, an office space, or other kinds of indoor space. The object BT can be a personnel or an article. Moreover, to determine the coordinate of the object BT, the receiver B12 of the present coordinate sensing device B1 can be installed on the object BT. In the relevant drawings following FIG. 9B, the collection of the object BT and the receiver B12 is labeled as BT/B12. For example, when the object BT is a personnel, the receiver B12 can be disposed in a mobile device (such as, in a mobile phone or tablet) carried by the personnel. Moreover, the receiver B12 can be disposed in a coordinate sensing device worn by the personnel (such as, a smart bracelet or ring worn by the personnel). Additionally, when the object BT is an article, the receiver B12 can be disposed on the article.

According to one embodiment of the present invention, the object BT and the receiver B12 can move freely in a horizontal plane BP of the locale; for example, the horizontal plane BP can be the ground of the locale. For simplicity and brevity, the object BT and the receiver B12 locate at a horizontal level that is substantially the same as the horizontal level of the horizontal plane BP. In other words, the object BT and the receiver B12 is in contact with a surface of the horizontal plane BP. However, the present invention is not limited thereto. In practical applications, the object BT and the receiver B12 are higher than the horizontal plane BP; nonetheless, this would not affect the operation of the present coordinate sensing device B1, and the present coordinate sensing device B1 can still output the coordinate of the object BT in the horizontal plane BP.

Moreover, the transmitter B11 of the coordinate sensing device B1 is disposed above the horizontal plane BP; that is, a horizontal level of the transmitter B11 is higher than the horizontal level of the horizontal plane BP. For example, the transmitter B11 can be installed on a ceiling, lighting fixture, smoke detector, air conditioner outlet, or other apparatuses in the locale.

According to one embodiment of the present invention, by disposing the transmitter B11 in combination with the receiver B12, the coordinate sensing device B1 can output any coordinate of the object BT in the horizontal plane BP in relative to the transmitter B11. In other words, the coordinate can be a two-dimensional coordinate or three-dimensional coordinate in the locale. However, for the sake of simplicity and brevity, the present embodiment is primarily directed to the operation of a coordinate sensing device B1 that outputs the two-dimensional coordinate of the object BT in the horizontal plane BP; that is, the respective distances in the x-axis and y-axis of the horizontal plane BP.

According to one embodiment of the present invention, as illustrated in FIG. 9B, the transmitter B11 emits a first light signal BS1 and a second light signal BS2 toward the horizontal plane BP, in which the first light signal BS1 and the second light signal BS2 have a pre-determined projection direction. In the present embodiment, the first light signal BS1 and the second light signal BS2 have the same projection direction. For example, the first light signal BS1 is substantially parallel to the second light signal BS2. When the first light signal BS1 and the second light signal BS2 are projected to the horizontal plane BP of the locale, the surface of the horizontal plane BP will present a first straight ray pattern (straight ray pattern) BL1 and a second straight ray pattern BL2, respectively. It should be noted that the first straight ray pattern BL1 and the second straight ray pattern BL2 can be an invisible pattern or visible pattern on the surface of the horizontal plane BP. According to one embodiment of the present invention, the transmitter B11 can be a laser transmitter, which may emit two parallel laser beams; the laser beam can be an infrared (IR) laser beam, or the laser beam can be a laser wall, while the first light signal BS1 and the second light signal BS2 can be a first laser wall and a second laser wall, respectively. It should be noted that the laser wall is a plane formed by beams. Since the laser wall of the first light signal BS1 is parallel to the laser wall of the second light signal BS2, the first straight ray pattern BL1 and the second straight ray pattern BL2 respectively formed by the first light signal BS1 and the second light signal BS2 in the horizontal plane BP are also two straight ray patterns that are parallel to each other, in which the distance or spacing between the first straight ray pattern BL1 and the second straight ray pattern BL2 has a fixed value, which is the so-called “pre-determined spacing”.

It should be noted that in another embodiment of the present invention, the first light signal BS1 and the second light signal BS2 may have different projection directions; for example, the respective projection directions of the first light signal BS1 and the second light signal BS2 form a pre-determined included angle, as illustrated in FIG. 9C, which is a schematic view illustrating the use of the coordinate sensing device B1a of the present invention to output a coordinate of an object BT according to another embodiment. As illustrated in FIG. 9C, the transmitter B11a can emit two non-parallel infrared laser beams BS1a, BS1b, wherein a pre-determined included angle Bβ is formed between the respective laser walls of the infrared laser beams BS1a, BS1b. Similarly, the infrared laser beams BS1a, BS1b can also form two parallel patterns (i.e., the first straight ray pattern BL1 and the second straight ray pattern BL2) in the horizontal plane BP. Accordingly, the present invention is not limited to any particular aspect of the lights emitted by the transmitter B11a. As long as the pre-determined included angle Bβ between the infrared laser beams BS1a, BS1b and distance between the transmitter B11a and horizontal plane BP (i.e., the height in the z-axis) are known, it is still feasible to compute the spacing between the first straight ray pattern BL1 and the second straight ray pattern BL2 in the horizontal plane BP. Moreover, when the object BT and the receiver B12 locate above the horizontal plane BP; that is, the horizontal level of the object BT and the receiver B12 is higher than the horizontal level of the horizontal plane BP, then, as long as the pre-determined included angle Bβ between the infrared laser beams BS1a, BS1b and the distance between the transmitter B11 and the receiver B12 (i.e., the object BT) are known, it is also feasible to compute the spacing between the first straight ray pattern BL1 and the second straight ray pattern BL2 at the horizontal level of the receiver B12.

FIG. 9D is a schematic view illustrating the use of a coordinate sensing device B1 of the present invention to output a coordinate of an object BT according to another embodiment. As illustrated in FIG. 9D, the transmitter B11 emits two parallel laser walls toward the horizontal plane BP, i.e., the first light signal BS1 and the second light signal BS2. When the two parallel laser walls reach the horizontal plane BP, two parallel straight ray patterns (that is the first straight ray pattern BL1 and the second straight ray pattern BL2) are formed in the horizontal plane BP. According to one embodiment of the present invention, a point in the horizontal plane BP that is right below the transmitter B11 is defined as a rotation center BO.

FIG. 9E is schematic view illustrating the use of a coordinate sensing device B1 of the present invention to output a coordinate of an object BT according to another embodiment. As illustrated in FIG. 9E, during the operation of the coordinate sensing device B1, the transmitter B11 controls the first light signal BS1 and the second light signal BS2 such that the first straight ray pattern BL1 and the second straight ray pattern BL2 rotate about the rotation center BO. In the present embodiment, the rotation direction is clockwise; however, the present invention is not limited thereto. In another embodiment, the rotation direction can also be counterclockwise. In one embodiment, the transmitter B11 controls the first light signal BS1 and the second light signal BS2 through a control unit (not shown in the drawings) such that the first straight ray pattern BL1 and the second straight ray pattern BL2 rotate about the rotation center BO simultaneously, and therefore, the lights forming the first straight ray pattern BL1 and the second straight ray pattern BL2 sequentially scan over (or pass through) the receiver B12 on the object BT. It should be noted that the rotation center BO of the present invention is not limited to the one on the horizontal plane BP right below the transmitter B11. In some other embodiments, the transmitter B11 itself also rotates in a different direction such that the rotation center BO on the horizontal plane BP also rotates simultaneously. Alternatively, in some other embodiments, the transmitter B11 itself does not rotate, and there are only the first straight ray pattern BL1 and the second straight ray pattern BL2 that rotate about the rotation center BO simultaneously.

When the first straight ray pattern BL1 and the second straight ray pattern BL2 rotate about the rotation center BO, the first straight ray pattern BL1, and the second straight ray pattern BL2 scan over the receiver B12 on the object BT at different time points. When the first straight ray pattern BL1 scan over the object BT, the receiver B12 on the object BT senses the light from the first straight ray pattern BL1, and accordingly, the receiver B12 outputs a first signal at a first time point. When the second straight ray pattern BL2 scan over the object BT, the receiver B12 on the object BT senses the light from the second straight ray pattern BL2, and accordingly, the receiver B12 outputs a second signal at a second time point. According to one embodiment of the present invention, the first signal and the second signal are respectively a first pulse signal and a second pulse signal.

FIG. 9F is a top view illustrating the use of a coordinate sensing device B1 of the present invention to scan an object BT according to another embodiment. When the first straight ray pattern BL1 and the second straight ray pattern BL2 rotate around the rotation center BO in the horizontal plane BP by 360 degrees, the four positions BA, BB, BC, BD on the first straight ray pattern BL1 and the second straight ray pattern BL2 sequentially scan over the receiver B12 on the object BT. The receiver B12 outputs four pulse signals at four corresponding time points, respectively, as illustrated in FIG. 9G. FIG. 9G is an oscillogram of a receiving signal BSr generated by a present receiver B12 according to one embodiment. The receiving signals BSr at the time points Bt1, Bt2, Bt3, Bt4 are four pulse signals BSp1, BSp2, BSp3, BSp4, respectively. According to one embodiment of the present invention, the pulse signals BSp1 and BSp2 correspond to the position BA of the first straight ray pattern BL1 and the position BB of the second straight ray pattern BL2, respectively; while the pulse signals BSp3 and BSp4 correspond to the position BC of the first straight ray pattern BL1 and the position BD of the second straight ray pattern BL2, respectively. Further, when the period of a full cycle of scanning of the first straight ray pattern BL1 and the second straight ray pattern BL2 is BTP, then the time difference between the respective central time points Bt1, Bt3 of the pulse signals BSp1, BSp3 or the time difference between the respective central time points Bt2, Bt4 of the pulse signals BSp2, BSp4 is half the scan period (BTP/2). The angular velocity to at which the first straight ray pattern BL1 and the second straight ray pattern BL2 rotate in the horizontal plane BP can be calculated from equation (1):

ω=2π/BTP (1)

Accordingly, the angular velocity co at which the first straight ray pattern BL1 and the second straight ray pattern BL2 rotate in the horizontal plane BP is a pre-determined angular velocity.

It should be noted that in order to avoid the issue that the noise light in the ambient environment might affect the accuracy of the receiver B12, in some embodiments, the coordinate sensing device B1, B1a can further comprise a filter (not shown in the drawings) disposed on the receiver B12, the filter is configured to allow only the passage of the first straight ray pattern BL1 and the second straight ray pattern BL2. By using the filter, it is possible to filter out the light other than the first straight ray pattern BL1 and the second straight ray pattern BL2, thereby improving the detection accuracy of the receiver B12.

FIG. 9H is a top view illustrating the use of a coordinate sensing device B1 of the present invention to scan an object BT according to another embodiment. As can be seen in FIG. 9H, when the first straight ray pattern BL1 and the second straight ray pattern BL2 continue to rotate in the horizontal plane BP about the rotation center BO, the first straight ray pattern BL1 and the second straight ray pattern BL2 sequentially scan over the receiver B12 on the object BT. The receiver B12 can sense the first straight ray pattern BL1 and the second straight ray pattern BL2 for multiple times at different time points. Therefore, the receiving signals BSr generated by the receiver B12 will have multiple sets of pulse signals.

Moreover, in the present embodiment, when the first straight ray pattern BL1 and the second straight ray pattern BL2 scan over the object BT, the transmitter B11 first uses the wireless transmission module B111 depicted in FIG. 9A to transmit a wireless signal BSn to the wireless transmission module B121 of the receiver B12. When the receiver B12 receives the wireless signal BSn, the receiver B12 generates a reference time Bt0. The reference time Bt0 is configured to synchronize the transmitter B11 and the receiver B12, and therefore, the wireless signal BSn can be viewed as a synchronizing signal. Furthermore, the transmitter B11 transmits the wireless signal BSn to the receiver B12 when the first straight ray pattern BL1 or the second straight ray pattern BL2 has a pre-determined angle or a reference angle (such as, 0 degree), such that the receiver B12 generates a reference time (i.e., Bt0). Next, whenever the first straight ray pattern BL1 or the second straight ray pattern BL2 rotates to said pre-determined angle or the reference angle, the transmitter B11 transmits the wireless signal BSn to the receiver B12, such that the receiver B12 generates a reference time (i.e., Bt0). In this way, the transmitter B11 and the receiver B12 are synchronized. FIG. 9I is an oscillogram of a receiving signal BSr generated by a present receiver B12 according to another embodiment. The receiving signals BSr, at the time points Bt1, Bt2, are two pulse signals BSp1, BSp2, respectively; the pulse signals BSp1, BSp2 correspond to the position BA of the first straight ray pattern BL1 and the position BB of the second straight ray pattern BL2, respectively. For the sake of simplicity and brevity, the two pulse signals respectively correspond to the position BC of the first straight ray pattern BL1 and the position BD of second straight ray pattern BL2 are omitted. According to one embodiment of the present invention, the receiver B12 receives the wireless signal BSn from the transmitter B11 at the reference time Bt0. Further, the receiving signal BSr generated by the receiver B12 is received and stored by the controller B13.

Moreover, there is a time interval (or time difference) Bt between the first time Bt1 and the second time Bt2, and the time difference is the time difference between the central time points of the pulse signal BSp1, BSp2; that is, Bt=Bt2−Bt1.

It should be noted that, when implementing this embodiment, the microprocessor within the controller B13 can record the time point of the rising or falling edge of two consecutive pulse signals BS1, BS2, so that it can further compute the central time points of the pulse signals BS1, BS2, thereby obtaining a more accurate time difference.

Moreover, a mean value of the first time Bt1 and the second time Bt2 can be calculated; the mean value is (Bt1+Bt2)/2. A time difference between the mean value and the reference time Bt0 is (Bt1+Bt2)/2−Bt0; this is the time required for the first straight ray pattern BL1 or second straight ray pattern BL2 to rotate from the reference angle to the receiver B12 of the object BT. Furthermore, a rotation angle ψ can be calculated by multiplying the time difference between the mean value (i.e., (Bt1+Bt2)/2) and the reference time Bt0 by the angular velocity co, see the following equation (2):

ψ=ω*((Bt1+Bt2)/2−Bt0) (2)

According to one embodiment of the present invention, the controller B13 uses the above-mentioned rotation angle ψ to compute the two-dimensional coordinate.

FIG. 9J is a top view illustrating the use of the present coordinate sensing device B1 to scan two objects BT1, BT2 according to one embodiment. In the present embodiment, both the two objects BT1, BT2 have a receiver B12 disposed thereon. As illustrated in FIG. 9J, when two objects BT1, BT2 is spaced from the rotation center BO with different distances, each of the objects BT1, BT2 forms a different scan angle Bθ1, Bθ2 with the rotation center BO; that is, Bθ1 is different from Bθ2. For example, the closer the distance between the object BT1 and the rotation center BO, the greater the scan angle Bθ1, and therefore, the greater the time difference between the first time Bt1 and the second time Bt2. This is because that when the distance between the object BT1 and rotation center BO gets closer, the speed at which the first straight ray pattern BL1 and the second straight ray pattern BL2 scan becomes slower, thereby leading to a longer time difference and a greater scan angle Bθ1. On the contrary, when the distance between the object BT2 and the rotation center BO gets farther, the scan angle Bθ2 becomes smaller, and hence, the time difference between the first time Bt1 and the second time Bt2 shortens. This is because that when the distance between the object BT2 and the rotation center BO gets farther, the speed at which the first straight ray pattern BL1 and the second straight ray pattern BL2 scan is faster, thereby leading to a shorter time difference and a smaller scan angle Bθ2.

FIG. 9K is a top view illustrating the use of the present coordinate sensing device B1 to scan an object BT according to one embodiment. As illustrated in FIG. 9K, in the present embodiment, there is a distance BS between the rotation center BO and the object BT, when viewed from the top, and the position at which the first straight ray pattern BL1 rotates and passes through the object BT is a first point position BP1. Meanwhile, for the second straight ray pattern BL2, there is a second point position BP2 that is spaced from the rotation center BO by the same distance BS. In this case, the first point position BP1 and the rotation center BO form a first straight line, the second point position BP2 and the rotation center BO form a second straight line, and the first straight line and the second straight line have an included angle Bθ therebetween. Since the first straight ray pattern BL1 and the second straight ray pattern BL2 have the pre-determined angular velocity ω when they rotate about the rotation center BO, the above-mentioned included angle Bθ would equal to the product of the pre-determined angular velocity ω and the time difference Bt, see the following equation (3):

Bθ=ω*Bt (3)

Moreover, there is a pre-determined spacing BS between the first straight ray pattern BL1 and the second straight ray pattern BL2 (in this embodiment, the spacing BS has a fixed value), and as illustrated in FIG. 9K, the relationship between the spacing BS and the distance Br satisfies the following equation (4):

Br=BS/(2*sin(ω*Bt/2)) (4)

Using the above-mentioned equation (2) and equation (4), the controller B13 may compute the angle ψ and the distance BS between the rotation center BO and the receiver B12 (i.e., the object BT). Next, the controller B13 may obtain the coordinate (x,y) representing the position of the object BT in the two-dimensional plane of the locale according to following equation (5):

x=Br*cos(ψ),y=Br*sin(ψ) (5)

where x is an x-coordinate distance of the object BT (or receiver B12) in the horizontal plane BP, and y is a y-coordinate distance of the object BT in the horizontal plane BP.

In view of the foregoing, the microprocessor of the controller B13 may compute two sets of coordinate position (x,y) of the object BT in the horizontal plane BP according to the angular velocity ω at which the first straight ray pattern BL1 and the second straight ray pattern BL2 rotate, the spacing BS between the first straight ray pattern BL1 and the second straight ray pattern BL2, the time difference Bt between the first time Bt1 and the second time Bt2, and the reference time Bt0. Therefore, the present invention embodiment may accurately determine the precise location of the object BT in a specific locale.

According to some embodiments, a monitoring apparatus includes: a first operational device arranged to perform a first predetermined function and accordingly transmit a first instruction signal; a second operational device arranged to receive a second instruction signal and accordingly perform a second predetermined function; a first monitoring device coupled to the first operational device for generating a first detecting event according to an operation of the first operational device; and a second monitoring device coupled to the second operational device for generating a second detecting event according to the operation of the second operational device. The first monitoring device is wirelessly coupled to the second monitoring device, and the first detecting event and the second detecting event are used to determine if the first operational device and the second operational device perform the first predetermined function and the second predetermined function respectively.

According to some embodiments, a monitoring method includes: arranging a first operational device to perform a first predetermined function and accordingly transmitting a first instruction signal; arranging a second operational device to receive a second instruction signal and accordingly performing a second predetermined function; generating a first detecting event according to an operation of the first operational device; generating a second detecting event according to the operation of the second operational device; and using the first detecting event and the second detecting event to determine if the first operational device and the second operational device perform the first predetermined function and the second predetermined function respectively.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A monitoring apparatus, comprising:
a first operational device, arranged to perform a first predetermined function and accordingly transmit a first instruction signal;
a second operational device, arranged to receive a second instruction signal and accordingly perform a second predetermined function;
a first monitoring device, coupled to the first operational device for generating a first detecting event according to an operation of the first operational device; and
a second monitoring device, coupled to the second operational device for generating a second detecting event according to the operation of the second operational device;
wherein the first monitoring device is wirelessly coupled to the second monitoring device, and the first detecting event and the second detecting event are used to determine if the first operational device and the second operational device perform the first predetermined function and the second predetermined function respectively.

2. The monitoring apparatus of claim 1, wherein the first monitoring device is substantially time synchronized to the second monitoring device.

3. The monitoring apparatus of claim 1, wherein the first monitoring device further transmits a packet having a timestamp attached to an end of the packet to the second monitoring device, and the second monitoring device receives the packet having the timestamp for performing a time synchronization with the first monitoring device.

4. The monitoring apparatus of claim 1, wherein the first monitoring device is time synchronized with the second monitoring device by using Reference Broadcast Synchronization (RBS).

5. The monitoring apparatus of claim 1, wherein the first detecting event includes a time at which the first operational device transmitting the first instruction signal occurs.

6. The monitoring apparatus of claim 1, wherein the second detecting event includes a time at which the second operational device receiving the second instruction signal occurs.

7. The monitoring apparatus of claim 1, wherein the second instruction signal received by the second operational device is the first instruction signal transmitted by the first operational device.

8. The monitoring apparatus of claim 1, wherein the first monitoring device further receives a first acknowledgement signal from the first operational device to generate the first detecting event, wherein the first acknowledgement signal indicates the first operational device transmitting the first instruction signal occurs.

9. The monitoring apparatus of claim 1, wherein the second monitoring device further receives a second acknowledgement signal from the first operational device to generate the second detecting event, wherein the second acknowledgement signal indicates the second operational device receiving the second instruction signal occurs.

10. The monitoring apparatus of claim 1, wherein the first monitoring device and the second monitoring device further supply power to the first operational device and the second operational device respectively.

11. The monitoring apparatus of claim 1, further comprising:
a processing device, coupled to the first monitoring device and the second monitoring device, for receiving the first detecting event and the second detecting event to determine if the first operational device and the second operational device perform the first predetermined function and the second predetermined function respectively.

12. The monitoring apparatus of claim 11, wherein the first monitoring device comprises:
a first power supply unit, arranged to supply power to the first operational device;
a first networking unit, arranged to wirelessly transmit the first detecting event to the processing device;
a first time synchronization unit, arranged to generate a first clock signal; and
a first signal measuring and analyzing unit, coupled to the first operational device, for analyzing a first acknowledgement signal received from the first operational device to obtain a first time at which the first operational device transmitting the first instruction signal occurs; and
the second monitoring device comprises:
a second power supply unit, arranged to provide power to the second operational device;
a second networking unit, arranged to wirelessly transmit the second detecting event to the processing device;
a second time synchronization unit, arranged to generate a second clock signal; and
a second signal measuring and analyzing unit, coupled to the second operational device, for analyzing a second acknowledgement signal received from the second operational device to obtain a second time at which the second operational device receiving the second instruction signal occurs.

13. The monitoring apparatus of claim 12, wherein the first clock signal is time synchronized to the second clock signal.

14. The monitoring apparatus of claim 12, wherein the first power supply unit further supplies power to the first networking unit, the first time synchronization unit, and the first signal measuring and analyzing unit.

15. The monitoring apparatus of claim 12, wherein the second power supply unit further supplies power to the second networking unit, the second time synchronization unit, and the second signal measuring and analyzing unit.

16. The monitoring apparatus of claim 12, further comprising:
a first connecting device, coupled between the first signal measuring and analyzing unit and the first operational device, for conveying the first acknowledgement signal; and
a second connecting device, coupled between the second signal measuring and analyzing unit and the second operational device, for conveying the second acknowledgement signal.

17. A monitoring method, comprising:
arranging a first operational device to perform a first predetermined function and accordingly transmitting a first instruction signal;
arranging a second operational device to receive a second instruction signal and accordingly performing a second predetermined function;
generating a first detecting event according to an operation of the first operational device;
generating a second detecting event according to the operation of the second operational device; and
using the first detecting event and the second detecting event to determine if the first operational device and the second operational device perform the first predetermined function and the second predetermined function respectively.

18. The monitoring method of claim 17, wherein the first detecting event includes a time at which the first operational device transmitting the first instruction signal occurs.

19. The monitoring method of claim 17, wherein the second detecting event includes a time at which the second operational device receiving the second instruction signal occurs.

20. The monitoring method of claim 17, wherein the second instruction signal received by the second operational device is the first instruction signal transmitted by the first operational device.

21. The monitoring method of claim 17, further comprising:
receiving a first acknowledgement signal from the first operational device to generate the first detecting event, wherein the first acknowledgement signal indicates the first operational device transmitting the first instruction signal occurs; and
receiving a second acknowledgement signal from the second operational device to generate the second detecting event, wherein the second acknowledgement signal indicates the second operational device receiving the second instruction signal occurs.

22. The monitoring method of claim 21, further comprising:
generating a first clock signal and a second clock signal;
analyzing the first acknowledgement signal to obtain a first time at which the first operational device transmitting the first instruction signal occurs; and
analyzing the second acknowledgement signal to obtain a second time at which the second operational device receiving the second instruction signal occurs.

23. The monitoring method of claim 22, wherein the first clock signal is time synchronized to the second clock signal.

24. The monitoring apparatus of claim 1, further comprising:
a coordinate sensing device, comprising:
a receiver, for sensing a first light signal, a second light signal, and a third light signal for generating a receiving signal; and
a controller, for outputting a coordinate of the receiver according to the receiving signal;
wherein when the first light signal, the second light signal, and the third light signal project to a horizontal plane, a first straight ray pattern, a second straight ray pattern, and a third straight ray pattern are formed on the horizontal plane.

25. The monitoring apparatus of claim 1, further comprising:
a coordinate sensing device, comprising:
a receiver, configured to sense a first light signal and a second light signal for generating a receiving signal; and
a controller, configured to compute a coordinate of the receiver according to the receiving signal;
wherein the first light signal and the second light signal have a pre-determined projection direction such that a first straight ray pattern and a second straight ray pattern are respectively formed on a horizontal plane.
